(19) United States
(12) Patent Application Publication
(10) Pub. No.: US 2018/0199062 A1
(43) Pub. Date: Jul. 12, 2018

(54) INTRA PREDICTION TECHNIQUES FOR VIDEO CODING

(71) Applicant: QUALCOMM Incorporated, San Diego, CA (US)

(72) Inventors: Kai Zhang, San Diego, CA (US); Jianle Chen, San Diego, CA (US); Vadim Seregin, San Diego, CA (US); Hsiao-Chiang Chuang, San Diego, CA (US); Xiang Li, San Diego, CA (US); Li Zhang, San Diego, CA (US); Cheng-Teh Hsieh, Del Mar, CA (US); Marta Karczewicz, San Diego, CA (US)

(21) Appl. No.: 15/866,287

(22) Filed: Jan. 9, 2018

Related U.S. Application Data
(60) Provisional application No. 62/445,207, filed on Jan. 11, 2017.

(51) Int. Cl. H04N 19/593; H04N 19/59; H04N 19/13; H04N 19/96

(52) U.S. Cl. CPC H04N 19/593; H04N 19/96; H04N 19/13; H04N 19/59

(57) ABSTRACT

A video decoder determines a current block of a current picture of video data has a size of P×Q, wherein P is a first value corresponding to a width of the current block and Q is a second value corresponding to a height of the current block, wherein P is not equal to Q, wherein the current block includes a short side and a long side, and wherein the first value added to the second value does not equal a value that is a power of 2; decodes the current block of video data using intra DC mode prediction, wherein decoding the current block of video data using intra DC mode prediction comprises performing a shift operation to calculate a DC value and generating a prediction block for the current block of video data using the calculated DC value; and outputs a decoded version of the current picture.

This application claims the benefit of U.S. Provisional Patent Application No. 62/445,207 filed 11 Jan. 2017, the entire content of which is incorporated herein by reference.

### TECHNICAL FIELD

This disclosure relates to video coding such as video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, CUs, and/or coding nodes. Pictures may be referred to as frames. Reference pictures may be referred to as reference frames.

Spatial or temporal prediction results in a predictive block for a block to be coded. Residual data represents pixel differences between the original block to be coded and the predictive block. For further compression, the residual data may be transformed from the pixel domain to a transform domain, resulting in residual transform coefficients, which then may be quantized. Entropy coding may be applied to achieve even more compression.

### SUMMARY

This disclosure describes techniques for coding a block of video data using intra prediction. For example, the techniques of this disclosure include coding a block of video data using intra DC mode prediction when the block of video data is a rectangle.

According to one example, a method of decoding video data includes determining a current block of a current picture of the video data has a size of P×Q, wherein P is a first value corresponding to a width of the current block and Q is a second value corresponding to a height of the current block, wherein P is not equal to Q, wherein the current block includes a short side and a long side, and wherein the first value added to the second value does not equal a value that is a power of 2; decoding the current block of video data using intra DC mode prediction, wherein decoding the current block of video data using intra DC mode prediction comprises: performing a shift operation to calculate a DC value; and generating a prediction block for the current block of video data using the calculated DC value; and outputting a decoded version of the current picture comprising a decoded version of the current block.

According to another example, a device for decoding video data includes one or more storage media configured to store the video data; and one or more processors configured to: determine a current block of a current picture of the video data has a size of P×Q, wherein P is a first value corresponding to a width of the current block and Q is a second value corresponding to a height of the current block, wherein P is not equal to Q, wherein the current block includes a short side and a long side, and wherein the first value added to the second value does not equal a value that is a power of 2; decode the current block of video data using intra DC mode prediction, wherein decoding the current block of video data using intra DC mode prediction comprises: perform a shift operation to calculate a DC value; and generate a prediction block for the current block of video data using the calculated DC value; and output a decoded version of the current picture comprising a decoded version of the current block.

According to another example, an apparatus for decoding video data include means for determining a current block of a current picture of the video data has a size of P×Q, wherein P is a first value corresponding to a width of the current block and Q is a second value corresponding to a height of the current block, wherein P is not equal to Q, wherein the current block includes a short side and a long side, and wherein the first value added to the second value does not equal a value that is a power of 2; means for decoding the current block of video data using intra DC mode prediction, wherein the means for decoding the current block of video data using intra DC mode prediction comprises: means for performing a shift operation to calculate a DC value; and means for generating a prediction block for the current block of video data using the calculated DC value; and means for outputting a decoded version of the current picture comprising a decoded version of the current block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system configured to implement techniques of the disclosure.

FIG. 2 is a conceptual diagram illustrating coding unit (CU) structure in High Efficiency Video Coding (HEVC).

FIG. 3 is a conceptual diagram illustrating example partition types for an inter prediction mode.

FIG. 4A is a conceptual diagram illustrating an example of block partitioning using a quad-tree-binary-tree (QTBT) structure.

FIG. 4B is a conceptual diagram illustrating an example tree structure corresponding to the block partitioning using the QTBT structure of FIG. 4A.

FIG. 5 is a conceptual diagram illustrating example asymmetric partitions according to one example of QTBT partitioning.

FIG. 6A illustrates a basic example of intra prediction in accordance with one example of the disclosure.

FIG. 6B illustrates an example of 33 different angular modes of intra prediction in accordance with one example of the disclosure.

FIG. 6C illustrates an example of intra planar mode prediction in accordance with one example of the disclosure.

FIG. 6D illustrates above neighboring samples and left neighboring samples bordering a current block in accordance with one example of the disclosure.

FIG. 7 illustrates an example of downsampling above neighboring samples bordering a current block in accordance with one example of the disclosure.

FIG. 8 illustrates an example of extending left neighboring samples bordering a current block in accordance with one example of the disclosure.

FIG. 9 illustrates an example of division elimination techniques.

FIG. 10 is a block diagram illustrating an example of a video encoder.

FIG. 11 is a block diagram illustrating an example of a video decoder.

FIG. 12 is a flowchart illustrating an example operation of a video decoder, in accordance with a technique of this disclosure.

FIG. 13 is a flowchart illustrating an example operation of a video decoder, in accordance with a technique of this disclosure.

### DETAILED DESCRIPTION

This disclosure describes techniques for coding a block of video data using intra prediction, and more particularly, this disclosure describes techniques related to coding non-square rectangular blocks, i.e. blocks with a height that does not equal the block's width. For example, the techniques of this disclosure include coding a non-square rectangular block of video data using intra DC prediction mode or using an intra strong filter. The techniques described herein may enable the use of a shift operation, where a division operation may otherwise be required, thereby potentially reducing computational complexity while maintaining a desired coding efficiency.

As used in this disclosure, the term video coding generically refers to either video encoding or video decoding. Similarly, the term video coder may generically refer to a video encoder or a video decoder. Moreover, certain techniques described in this disclosure with respect to video decoding may also apply to video encoding, and vice versa. For example, often times video encoders and video decoders are configured to perform the same process, or reciprocal processes. Also, video encoders typically perform video decoding as part of the processes of determining how to encode video data. Thus, unless stated to the contrary, it should not be assumed that a technique described with respect to video decoding cannot also be performed as part of video encoding, or vice versa.

This disclosure may also use terms such as current layer, current block, current picture, current slice, etc. In the context of this disclosure, the term current is intended to identify a block, picture, slice, etc. that is currently being coded, as opposed to, for example, previously or already coded blocks, pictures, and slices or yet to be coded blocks, pictures, and slices.

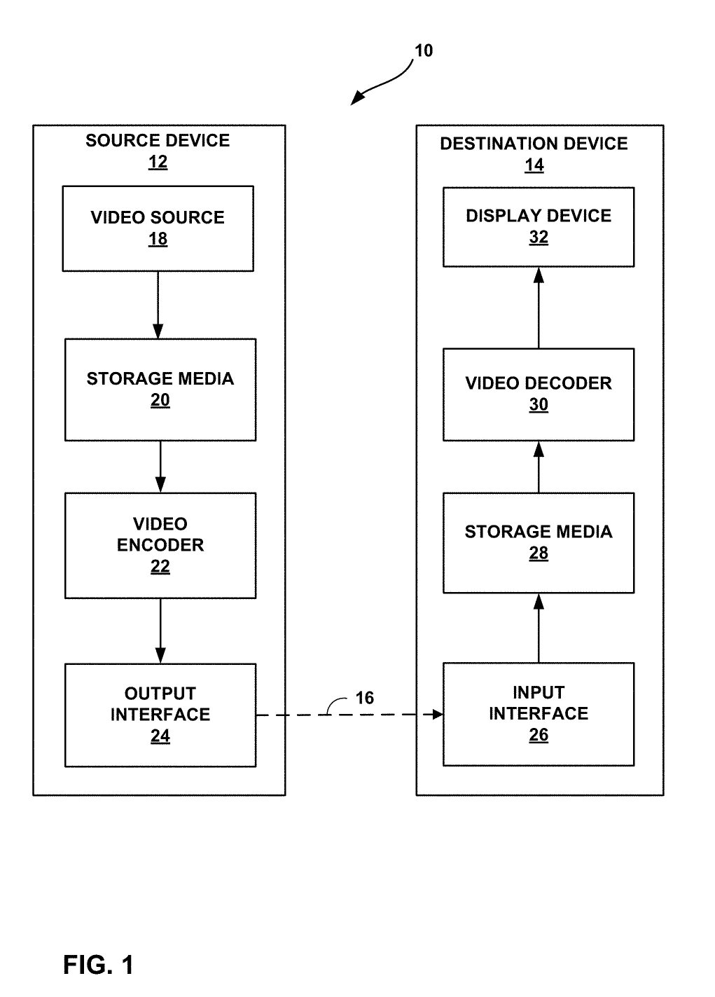

FIG. 1 is a block diagram illustrating an example video encoding and decoding system 10 that may utilize techniques of this disclosure for coding a block of video data using intra DC mode prediction when the block of video data is a rectangle. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, tablet computers, televisions, cameras, display devices, digital media players, video gaming consoles, video streaming device, or the like. In some cases, source device 12 and destination device 14 may be equipped for wireless communication. Thus, source device 12 and destination device 14 may be wireless communication devices. Source device 12 is an example video encoding device (i.e., a device for encoding video data). Destination device 14 is an example video decoding device (e.g., a device or apparatus for decoding video data).

In the example of FIG. 1, source device 12 includes a video source 18, a storage media 20 configured to store video data, a video encoder 22, and an output interface 24. Destination device 14 includes an input interface 26, a storage medium 28 configured to store encoded video data, a video decoder 30, and display device 32. In other examples, source device 12 and destination device 14 include other components or arrangements. For example, source device 12 may receive video data from an external video source, such as an external camera. Likewise, destination device 14 may interface with an external display device, rather than including an integrated display device.

The illustrated system 10 of FIG. 1 is merely one example. Techniques for processing video data may be performed by any digital video encoding and/or decoding device or apparatus. Although generally the techniques of this disclosure are performed by a video encoding device and a video decoding device, the techniques may also be performed by a combined video encoder/decoder, typically referred to as a “CODEC.” Source device 12 and destination device 14 are merely examples of such coding devices in which source device 12 generates encoded video data for transmission to destination device 14. In some examples, source device 12 and destination device 14 operate in a substantially symmetrical manner such that each of source device 12 and destination device 14 include video encoding and decoding components. Hence, system 10 may support one-way or two-way video transmission between source device 12 and destination device 14, e.g., for video streaming, video playback, video broadcasting, or video telephony.

Video source 18 of source device 12 may include a video capture device, such as a video camera, a video archive containing previously captured video, and/or a video feed interface to receive video data from a video content provider. As a further alternative, video source 18 may generate computer graphics-based data as the source video, or a combination of live video, archived video, and computer-generated video. Source device 12 may comprise one or more data storage media (e.g., storage media 20) configured to store the video data. The techniques described in this disclosure may be applicable to video coding in general, and may be applied to wireless and/or wired applications. In each case, the captured, pre-captured, or computer-generated video may be encoded by video encoder 22. Output interface 24 may output the encoded video information to computer-readable medium 16.

Destination device 14 may receive the encoded video data to be decoded via computer-readable medium 16. Computer-readable medium 16 may comprise any type of medium or device capable of moving the encoded video data from source device 12 to destination device 14. In some examples, computer-readable medium 16 comprises a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14. Destination device 14 may comprise one or more data storage media configured to store encoded video data and decoded video data.

In some examples, encoded data (e.g., encoded video data) may be output from output interface 24 to a storage device. Similarly, encoded data may be accessed from the storage device by input interface 26. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 26 of destination device 14 receives information from computer-readable medium 16. The information of computer-readable medium 16 may include syntax information defined by video encoder 22 of video encoder 22, which is also used by video decoder 30, that includes syntax elements that describe characteristics and/or processing of blocks and other coded units, e.g., groups of pictures (GOPs). Storage media 28 may store encoded video data received by input interface 26. Display device 32 displays the decoded video data to a user. Display device 32 may comprise any of a variety of display devices such as a cathode ray tube (CRT), a liquid crystal display (LCD), a plasma display, an organic light emitting diode (OLED) display, or another type of display device.

Video encoder 22 and video decoder 30 each may be implemented as any of a variety of suitable encoder or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and may execute the instructions in hardware using one or more processors to perform the techniques of this disclosure. Each of video encoder 22 and video decoder 30 may be included in one or more encoders or decoders, either of which may be integrated as part of a combined encoder/decoder (CODEC) in a respective device.

In some examples, video encoder 22 and video decoder 30 may operate according to a video coding standard. Example video coding standards include, but are not limited to, ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-View Video Coding (MVC) extensions. The video coding standard High Efficiency Video Coding (HEVC) or ITU-T H.265, including its range and screen content coding extensions, 3D video coding (3D-HEVC) and multiview extensions (MV-HEVC) and scalable extension (SHVC), has been developed by the Joint Collaboration Team on Video Coding (JCT-VC) of ITU-T Video Coding Experts Group (VCEG) and ISO/IEC Motion Picture Experts Group (MPEG). The latest HEVC draft specification, and referred to as HEVC WD hereinafter, is available from http://phenix.int-evry.fr/jct/doc_end_user/documents/14_Vienna/wgllaCTVC-N1003-vl.zip.

In HEVC and other video coding specifications, a video sequence typically includes a series of pictures. Pictures may also be referred to as “frames.” A picture may include three sample arrays, denoted S_{L}, S_{Cb}, and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

Furthermore, in HEVC and other video coding specifications, to generate an encoded representation of a picture, video encoder 22 may generate a set of coding tree units (CTUs). Each of the CTUs may comprise a coding tree block of luma samples, two corresponding coding tree blocks of chroma samples, and syntax structures used to code the samples of the coding tree blocks. In monochrome pictures or pictures having three separate color planes, a CTU may comprise a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in a raster scan order.

If operating according to HEVC, to generate a coded CTU, video encoder 22 may recursively perform quad-tree partitioning on the coding tree blocks of a CTU to divide the coding tree blocks into coding blocks, hence the name “coding tree units.” A coding block is an N×N block of samples. A CU may comprise a coding block of luma samples and two corresponding coding blocks of chroma samples of a picture that has a luma sample array, a Cb sample array, and a Cr sample array, and syntax structures used to code the samples of the coding blocks. In monochrome pictures or pictures having three separate color planes, a CU may comprise a single coding block and syntax structures used to code the samples of the coding block.

Syntax data within a bitstream may also define a size for the CTU. A slice includes a number of consecutive CTUs in coding order. A video frame or picture may be partitioned into one or more slices. As mentioned above, each tree block may be split into CUs according to a quad-tree. In general, a quad-tree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. If a block of CU is split further, it may be generally referred to as a non-leaf-CU. In some examples of this disclosure, four sub-CUs of a leaf-CU may be referred to as leaf-CUs even if there is no explicit splitting of the original leaf-CU. For example, if a CU at 16×16 size is not split further, the four 8×8 sub-CUs may also be referred to as leaf-CUs although the 16×16 CU was never split.

A CU has a similar purpose as a macroblock of the H.264 standard, except that a CU does not have a size distinction. For example, a tree block may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a tree block may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node as well as prediction units (PUs) and transform units (TUs) associated with the coding node. A size of the CU corresponds to a size of the coding node and may be, in some examples, square in shape. In the example of HEVC, the size of the CU may range from 8×8 pixels up to the size of the tree block with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs. The TUs may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quad-tree structure, sometimes called a “residual quad tree” (RQT). The leaf nodes of the RQT may be referred to as TUs. Pixel difference values associated with the TUs may be transformed to produce transform coefficients, which may be quantized.

A leaf-CU may include one or more PUs. In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a RQT, which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more TUs. The TUs may be specified using an RQT (also referred to as a TU quad-tree structure), as discussed above. For example, a split flag may indicate whether a leaf-CU is split into four transform units. In some examples, each transform unit may be split further into further sub-TUs. When a TU is not split further, it may be referred to as a leaf-TU. Generally, for intra coding, all the leaf-TUs belonging to a leaf-CU contain residual data produced from the same intra prediction mode. That is, the same intra-prediction mode is generally applied to calculate predicted values that will be transformed in all TUs of a leaf-CU. For intra coding, video encoder 22 may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective RQT structures. That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU).

As discussed above, video encoder 22 may partition a coding block of a CU into one or more prediction blocks. A prediction block is a rectangular (i.e., square or non-square) block of samples on which the same prediction is applied. A PU of a CU may comprise a prediction block of luma samples, two corresponding prediction blocks of chroma samples, and syntax structures used to predict the prediction blocks. In monochrome pictures or pictures having three separate color planes, a PU may comprise a single prediction block and syntax structures used to predict the prediction block. Video encoder 22 may generate predictive blocks (e.g., luma, Cb, and Cr predictive blocks) for prediction blocks (e.g., luma, Cb, and Cr prediction blocks) of each PU of the CU.

Video encoder 22 may use intra prediction or inter prediction to generate the predictive blocks for a PU. If video encoder 22 uses intra prediction to generate the predictive blocks of a PU, video encoder 22 may generate the predictive blocks of the PU based on decoded samples of the picture that includes the PU.

After video encoder 22 generates predictive blocks (e.g., luma, Cb, and Cr predictive blocks) for one or more PUs of a CU, video encoder 22 may generate one or more residual blocks for the CU. For instance, video encoder 22 may generate a luma residual block for the CU. Each sample in the CU's luma residual block indicates a difference between a luma sample in one of the CU's predictive luma blocks and a corresponding sample in the CU's original luma coding block. In addition, video encoder 22 may generate a Cb residual block for the CU. Each sample in the Cb residual block of a CU may indicate a difference between a Cb sample in one of the CU's predictive Cb blocks and a corresponding sample in the CU's original Cb coding block. Video encoder 22 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, as discussed above, video encoder 22 may use quad-tree partitioning to decompose the residual blocks (e.g., the luma, Cb, and Cr residual blocks) of a CU into one or more transform blocks (e.g., luma, Cb, and Cr transform blocks). A transform block is a rectangular (e.g., square or non-square) block of samples on which the same transform is applied. A transform unit (TU) of a CU may comprise a transform block of luma samples, two corresponding transform blocks of chroma samples, and syntax structures used to transform the transform block samples. Thus, each TU of a CU may have a luma transform block, a Cb transform block, and a Cr transform block. The luma transform block of the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

Video encoder 22 may apply one or more transforms a transform block of a TU to generate a coefficient block for the TU. For instance, video encoder 22 may apply one or more transforms to a luma transform block of a TU to generate a luma coefficient block for the TU. A coefficient block may be a two-dimensional array of transform coefficients. A transform coefficient may be a scalar quantity. Video encoder 22 may apply one or more transforms to a Cb transform block of a TU to generate a Cb coefficient block for the TU. Video encoder 22 may apply one or more transforms to a Cr transform block of a TU to generate a Cr coefficient block for the TU.

In some examples, video encoder 22 skips application of the transforms to the transform block. In such examples, video encoder 22 may treat residual sample values in the same way as transform coefficients. Thus, in examples where video encoder 22 skips application of the transforms, the following discussion of transform coefficients and coefficient blocks may be applicable to transform blocks of residual samples.

After generating a coefficient block (e.g., a luma coefficient block, a Cb coefficient block or a Cr coefficient block), video encoder 22 may quantize the coefficient block to possibly reduce the amount of data used to represent the coefficient block, potentially providing further compression. Quantization generally refers to a process in which a range of values is compressed to a single value. For example, quantization may be done by dividing a value by a constant, and then rounding to the nearest integer. To quantize the coefficient block, video encoder 22 may quantize transform coefficients of the coefficient block. After video encoder 22 quantizes a coefficient block, video encoder 22 may entropy encode syntax elements indicating the quantized transform coefficients. For example, video encoder 22 may perform Context-Adaptive Binary Arithmetic Coding (CABAC) or other entropy coding techniques on the syntax elements indicating the quantized transform coefficients.

Video encoder 22 may output a bitstream that includes a sequence of bits that forms a representation of coded pictures and associated data. Thus, the bitstream comprises an encoded representation of video data. The bitstream may comprise a sequence of network abstraction layer (NAL) units. A NAL unit is a syntax structure containing an indication of the type of data in the NAL unit and bytes containing that data in the form of a raw byte sequence payload (RBSP) interspersed as necessary with emulation prevention bits. Each of the NAL units may include a NAL unit header and may encapsulate a RBSP. The NAL unit header may include a syntax element indicating a NAL unit type code. The NAL unit type code specified by the NAL unit header of a NAL unit indicates the type of the NAL unit. A RB SP may be a syntax structure containing an integer number of bytes that is encapsulated within a NAL unit. In some instances, an RBSP includes zero bits.

Video decoder 30 may receive a bitstream generated by video encoder 22. Video decoder 30 may decode the bitstream to reconstruct pictures of the video data. As part of decoding the bitstream, video decoder 30 may parse the bitstream to obtain syntax elements from the bitstream. Video decoder 30 may reconstruct the pictures of the video data based at least in part on the syntax elements obtained from the bitstream. The process to reconstruct the video data may be generally reciprocal to the process performed by video encoder 22. For instance, video decoder 30 may use motion vectors of PUs to determine predictive blocks for the PUs of a current CU. In addition, video decoder 30 may inverse quantize coefficient blocks of TUs of the current CU. Video decoder 30 may perform inverse transforms on the coefficient blocks to reconstruct transform blocks of the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

Common concepts and certain design aspects of HEVC are described below, focusing on techniques for block partition. In HEVC, the largest coding unit in a slice is called a CTU. The size of a CTU may range from 16×16 to 64×64 in the HEVC main profile, although 8×8 CTU sizes may also be supported. Therefore, the size of a CTU in HEVC may range from 8×8 to 64×64. In some examples, a CU may be the same size of a CTU. Each CU is coded with one coding mode, such as an intra coding mode or an inter coding mode. Other coding modes are also possible, including coding modes for screen content (e.g., intra block copy modes, palette-based coding modes, etc.). When a CU is inter coded (i.e., inter mode is applied), the CU may be further partitioned into prediction units (PUs). For example, a CU may be partitioned in to 2 or 4 PUs. In another example, the entire CU is treated as a single PU when further partitioning is not applied. In HEVC examples, when two PUs are present in one CU, the two PUs can be half size rectangles or two rectangle size with ¼ or ¾ size of the CU. A CTU may include a coding tree block (CTB) for each luma and chroma component. A CTB may include one or more coding blocks (CBs). A CB may also be referred to as a CU in some examples. In some examples, the term CU may be used to refer to a binary-tree leaf node.

For an I slice, a luma-chroma-separated block partitioning structure is proposed. The luma component of one CTU (i.e., the luma CTB) is partitioned by a QTBT structure into luma CBs, and the two chroma components (e.g., Cr and Cb) of that CTU (i.e., the two chroma CTBs) are partitioned by another QTBT structure into chroma CBs.

For P and B slices, the block partitioning structure for luma and chroma is shared. That is, one CTU (including both luma and chroma) is partitioned by one QTBT structure into CUs.

When a CU is inter coded, one set of motion information (e.g., motion vector, prediction direction, and reference picture) is present for each PU. In addition, each PU is coded with a unique inter prediction mode to derive the set of motion information. However, it should be understood that even if two PUs are coded uniquely, the two PUs may still have the same motion information in some circumstances.

In J. An et al., “Block partitioning structure for next generation video coding,” International Telecommunication Union, COM16-C966, September 2015 (hereinafter, “VCEG proposal COM16-C966”), quad-tree-binary-tree (QTBT) partitioning techniques were proposed for future video coding standard beyond HEVC. Simulations have shown that the proposed QTBT structure is more efficient than the quad-tree structure in used HEVC. The QTBT structure, such as that described in H. Huang, K. Zhang, Y.-W. Huang, S. Lei, “EE2.1: Quadtree plus binary tree structure integration with JEM tools”, JVET-00024, June, 2016, is adopted in JEM software. Adoption of the QTBT structure in JEM software is described in J. Chen, E. Alshina, G. J. Sullivan, J.-R. Ohm, J. Boyce, “Algorithm Description of Joint Exploration Test Model 4,” JVET-D1001, October, 2016. JEM software is based on the HEVC Model (HM) software that is reference software for the Joint Video Exploration Team (JVET) group.

In the QTBT structure, a CTU (or CTB for an I slice), which is the root node of a quadtree, is firstly partitioned by a quadtree structure. The quadtree leaf nodes may be further partitioned by a binary tree structure. The binary tree leaf nodes, namely coding blocks (CBs), may be used for prediction and transform without any further partitioning. For P and B slices, the luma and chroma CTBs in one CTU share the same QTBT structure. For an I slice, the luma CTB may be partitioned into CBs by a QTBT structure, and two chroma CTBs may be partitioned into chroma CBs by another QTBT structure.

The minimum allowed quad-tree leaf node size may be indicated to video decoder by the value of the syntax element MinQTSize. If the quadtree leaf node size is not larger than the maximum allowed binary tree root node size (e.g., as denoted by a syntax element MaxBTSize), the quad-tree leaf node can be further partitioned using binary-tree partitioning. The binary-tree partitioning of one node can be iterated until the node reaches the minimum allowed binary-tree leaf node size (e.g., as denoted by a syntax element MinBTSize) or the maximum allowed binary-tree depth (e.g., as denoted by a syntax element MaxBTDepth). The binary tree leaf node, such as a CU (or a CB for an I slice), will be used for prediction (e.g. intra-picture or inter-picture prediction) and transform without any further partitioning. In general, according to QTBT techniques, there are two splitting types for binary-tree splitting: symmetric horizontal splitting and symmetric vertical splitting. In each case, a block is split by dividing the block down the middle, either horizontally or vertically.

In one example of the QTBT partitioning structure, the CTU size is set as 128×128 (e.g., a 128×128 luma block, a corresponding 64×64 chroma Cr block, and a corresponding 64×64 chroma Cb block), the MinQTSize is set as 16×16, the MaxBTSize is set as 64×64, the MinBTSize (for both width and height) is set as 4, and the MaxBTDepth is set as 4. The quad-tree partitioning is applied to the CTU first to generate quad-tree leaf nodes. The quad-tree leaf nodes may have a size from 16×16 (i.e., the MinQTSize is 16×16) to 128×128 (i.e., the CTU size). According to one example of QTBT partitioning, if the leaf quad-tree node is 128×128, the leaf quad-tree node cannot be further split by the binary-tree since the size of the leaf quad-tree node exceeds the MaxBTSize (i.e., 64×64). Otherwise, the leaf quad-tree node is further partitioned by the binary-tree. Therefore, the quad-tree leaf node is also the root node for the binary-tree and its binary-tree depth is defined as 0. The binary-tree depth reaching MaxBTDepth (e.g., 4) implies that there is no further splitting. The binary-tree node having a width equal to the MinBTSize (e.g., 4) implies that there is no further horizontal splitting. Similarly, the binary-tree node having a height equal to MinBTSize implies no further vertical splitting. The leaf nodes of the binary-tree (e.g., the CUs) are are further processed (e.g., by performing a prediction process and a transform process) without any further partitioning.

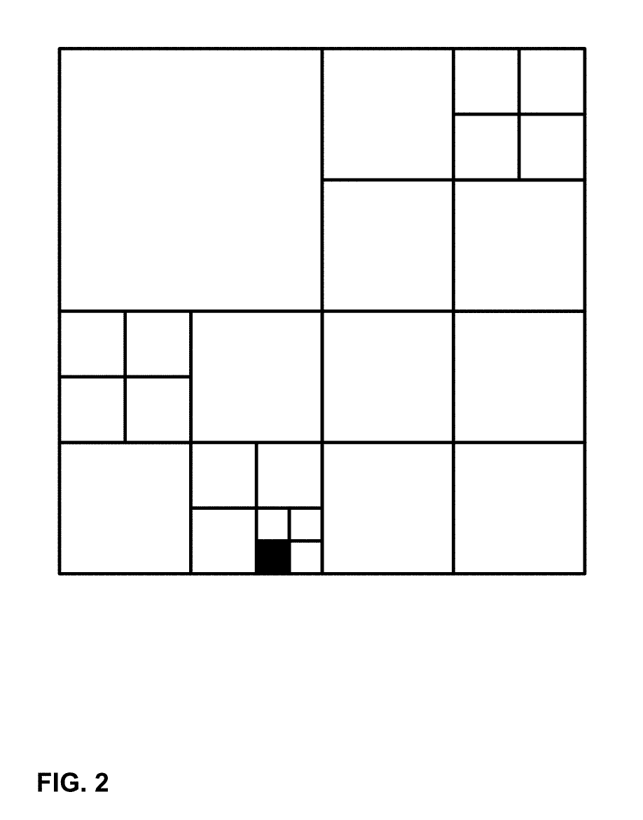

As shown in FIG. 2, each level of partitioning is a quad-tree split into four sub-blocks. The black block is an example of a leaf-node (i.e., a block that is not further split). A CTU is divided according to a quad-tree structure, the nodes of which are coding units. The plurality of nodes in a quad-tree structure includes leaf nodes and non-leaf nodes. The leaf nodes have no child nodes in the tree structure (i.e., the leaf nodes are not further split). The non-leaf nodes include a root node of the tree structure. The root node corresponds to an initial video block of the video data (e.g., a CTB). For each respective non-root node of the plurality of nodes, the respective non-root node corresponds to a video block that is a sub-block of a video block corresponding to a parent node in the tree structure of the respective non-root node. Each respective non-leaf node of the plurality of non-leaf nodes has one or more child nodes in the tree structure.

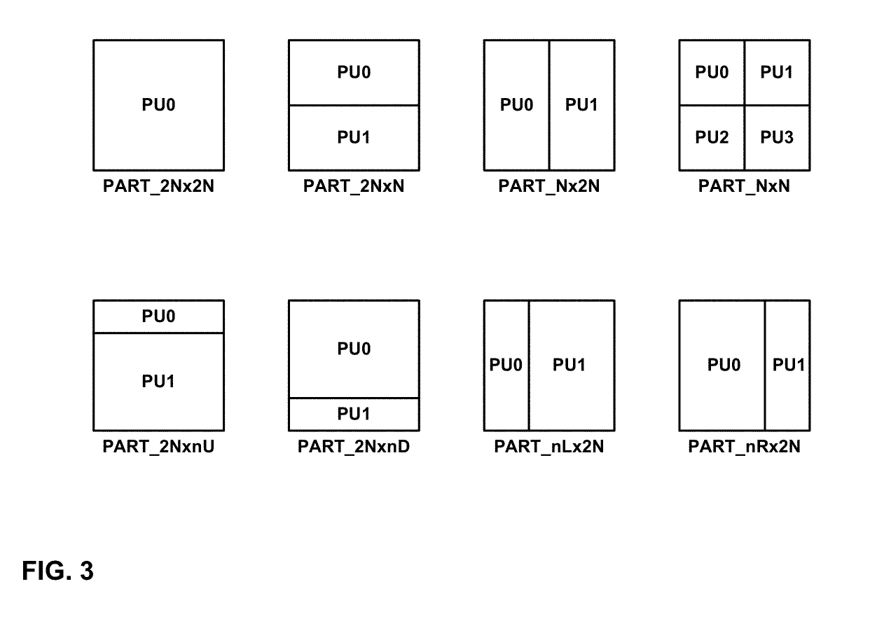

In HEVC, there are eight partition modes for a CU coded with inter prediction mode, i.e., PART_2N×2N, PART_2N×N, PART N×2N, PART N×N, PART_2N×nU, PART_2N×nD, PART_nL×2N and PART_nR×2N, as shown in FIG. 3. As shown in FIG. 3, a CU coded with partition mode PART_2N×2N is not further split. That is, the entire CU is treated as a single PU (PU0). A CU coded with partition mode PART_2N×N is symmetrically horizontally split into two PUs (PU0 and PU1). A CU coded with partition mode PART N×2N is symmetrically vertically split into two PUs. A CU coded with partition mode PART N×N is symmetrically split into four equal-sized PUs (PU0, PU1, PU2, PU3).

A CU coded with partition mode PART_2N×nU is asymmetrically horizontally split into one PU0 (the upper PU) having ¼ the size of the CU and one PU1 (the lower PU) having ¾ the size of the CU. A CU coded with partition mode PART_2N×nD is asymmetrically horizontally split into one PU0 (the upper PU) having ¾ the size of the CU and one PU1 (the lower PU) having ¼ the size of the CU. A CU coded with partition mode PART_nL×2N is asymmetrically vertically split into one PU0 (the left PU) having ¼ the size of the CU and one PU1 (the right PU) having ¾ the size of the CU. A CU coded with partition mode PART_nR×2N is asymmetrically vertically split into one PU0 (the left PU) having ¾ the size of the CU and one PU1 (the right PU) having ¼ the size of the CU.

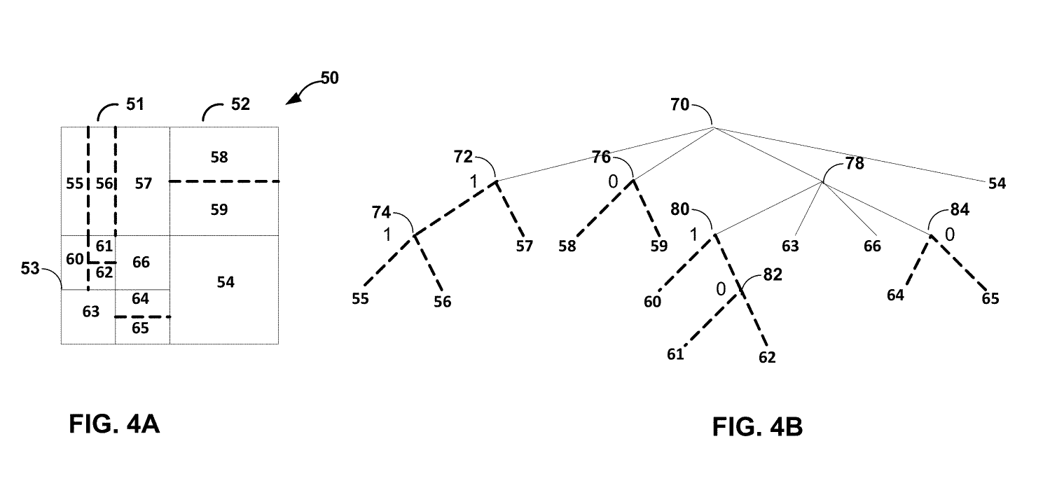

FIG. 4A illustrates an example of a block 50 (e.g., a CTB) partitioned using QTBT partitioning techniques. As shown in FIG. 4A, using QTBT partition techniques, each of the resultant blocks is split symmetrically through the center of each block. FIG. 4B illustrates the tree structure corresponding to the block partitioning of FIG. 4B. The solid lines in FIG. 4B indicate quad-tree splitting and dotted lines indicate binary-tree splitting. In one example, in each splitting (i.e., non-leaf) node of the binary-tree, a syntax element (e.g., a flag) is signaled to indicate the type of splitting performed (e.g., horizontal or vertical), where 0 indicates horizontal splitting and 1 indicates vertical splitting. For the quad-tree splitting, there is no need to indicate the splitting type, as quad-tree splitting always splits a block horizontally and vertically into 4 sub-blocks of equal size.

As shown in FIG. 4B, at node 70, block 50 is split into the four blocks 51, 52, 53, and 54, shown in FIG. 4A, using QT partitioning. Block 54 is not further split, and is therefore a leaf node. At node 72, block 51 is further split into two blocks using BT partitioning. As shown in FIG. 4B, node 72 is marked with a 1, indicating vertical splitting. As such, the splitting at node 72 results in block 57 and the block including both blocks 55 and 56. Blocks 55 and 56 are created by a further vertical splitting at node 74. At node 76, block 52 is further split into two blocks 58 and 59 using BT partitioning. As shown in FIG. 4B, node 76 is marked with a 1, indicating horizontal splitting.

At node 78, block 53 is split into 4 equal size blocks using QT partitioning. Blocks 63 and 66 are created from this QT partitioning and are not further split. At node 80, the upper left block is first split using vertical binary-tree splitting resulting in block 60 and a right vertical block. The right vertical block is then split using horizontal binary-tree splitting into blocks 61 and 62. The lower right block created from the quad-tree splitting at node 78, is split at node 84 using horizontal binary-tree splitting into blocks 64 and 65.

In one example in accordance with the techniques of this disclosure, video encoder 22 and/or video decoder 30 may be configured to receive a current block of video data having a size of P×Q. In some examples, the current block of video data may be referred to as a coded representation of a current block of video data. In some examples, P may be a first value corresponding to a width of the current block and Q may be a second value corresponding to a height of the current block. The height and width of the current block, e.g., the values for the P and Q, may be expressed in terms of number of samples. In some examples, P may not be equal to Q; and, in such examples, the current block includes a short side and a long side. If for example, the value of Q is greater than the value of P, then the left side of the block is the long side the and the top side is the short side. If for example, the value of Q is less than the value of P, then the left side of the block is the short side the and the top side is the long side.

Video encoder 22 and/or video decoder 30 may be configured to decode the current block of video data using intra DC mode prediction. In some examples, coding the current block of video data using intra DC mode prediction may include determining that the first value added to the second value does not equal a power of 2; sampling, to generate a number of sampled neighboring samples, at least one of a number of samples neighboring the short side or a number of samples neighboring the long side; and generating a prediction block for the current block of video data by calculating a DC value using the number of sampled neighboring samples.

Thus, in one example, video encoder 22 may generate an encoded representation of an initial video block (e.g., a coding tree block or CTU) of video data. As part of generating the encoded representation of the initial video block, video encoder 22 determines a tree structure comprising a plurality of nodes. For example, video encoder 22 may partition a tree block using a QTBT structure.

The plurality of nodes in the QTBT structure may include a plurality of leaf nodes and a plurality of non-leaf nodes. The leaf nodes have no child nodes in the tree structure. The non-leaf nodes include a root node of the tree structure. The root node corresponds to the initial video block. For each respective non-root node of the plurality of nodes, the respective non-root node corresponds to a video block (e.g., a coding block) that is a sub-block of a video block corresponding to a parent node in the tree structure of the respective non-root node. Each respective non-leaf node of the plurality of non-leaf nodes has one or more child nodes in the tree structure. In some examples, a non-leaf node at a picture boundary may only have one child node due to a forced split and one of the child nodes corresponds to a block outside the picture boundary.

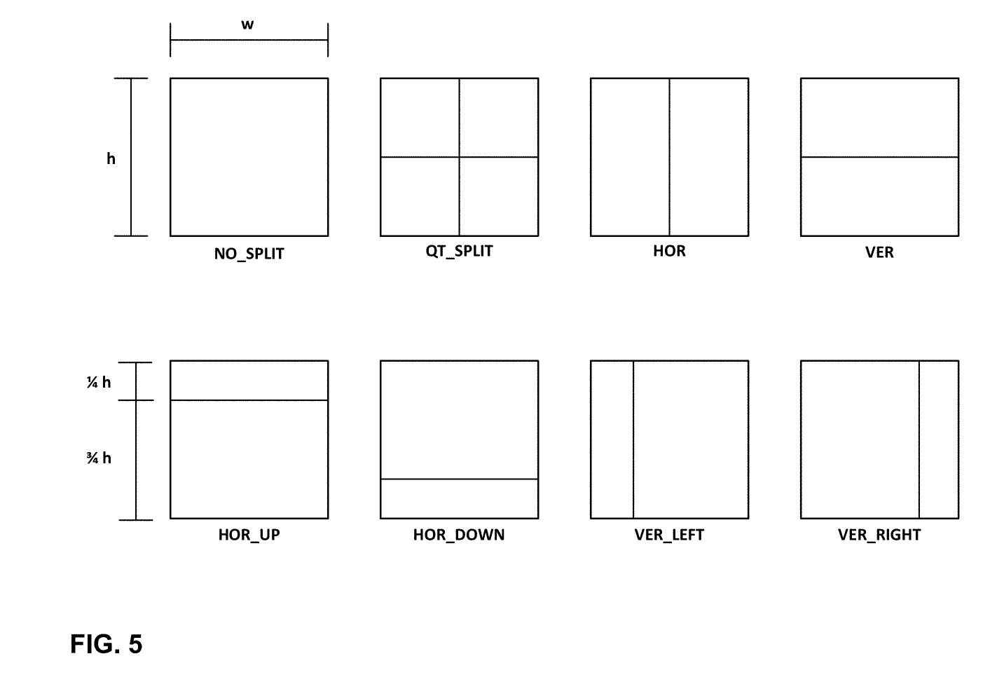

In F. Le Léannec, T. Poirier, F. Urban, “Asymmetric Coding Units in QTBT”, JVET-D0064, Chengdu, October 2016 (hereinafter “NET-D0064”), asymmetric coding units were proposed to be used in conjunction with QTBT. Four new binary-tree splitting modes (e.g., partition types) were introduced into the QTBT framework, so as to allow new splitting configurations. So-called asymmetric splitting modes were proposed in addition to the splitting modes already available in QTBT, as shown by FIG. 5. As shown in FIG. 5, the HOR_UP, HOR_DOWN, VER_LEFT, and VER_RIGHT partition types are examples of asymmetric splitting modes.

According to the added asymmetric splitting modes, a coding unit with size S is divided into 2 sub-CU with sizes S/4 and 3. S/4, either in the horizontal (e.g., HOR_UP or HOR_DOWN) or in the vertical (e.g., VER_LEFT or VER_RIGHT) direction. In NET-D0064 the newly added CU width or height could only be 12 or 24.

In asymmetric coding units (e.g., those shown in FIG. 5), transforms with a size not being equal to a power of 2 are introduced, such as 12 and 24. Accordingly, such asymmetric coding units introduce more factors which cannot be compensated in the transform process. Additional processing may be necessary to perform the transform or inverse transform on such asymmetric coding units.

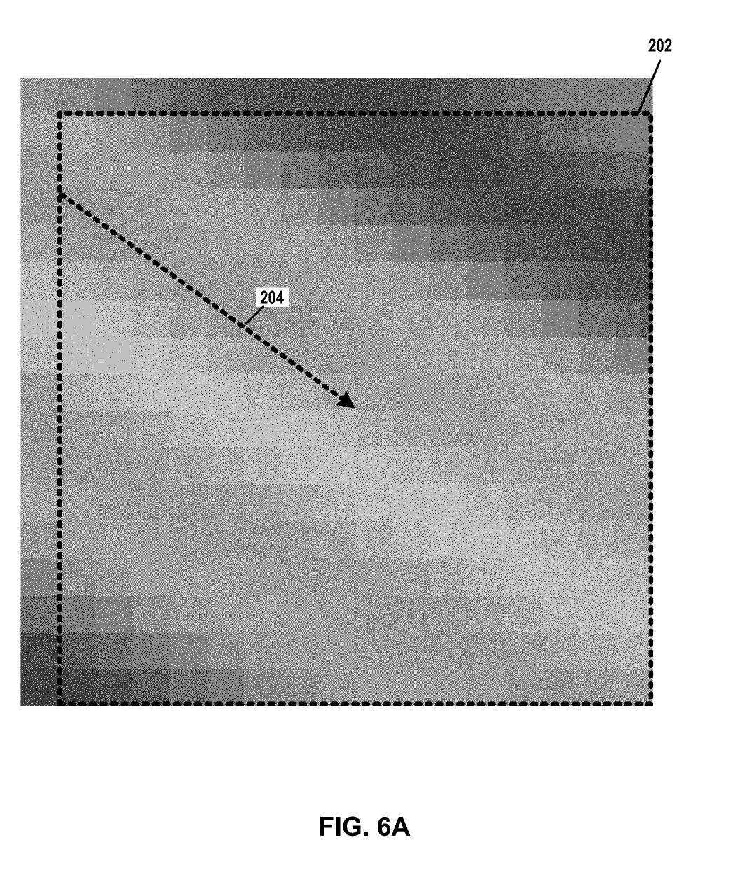

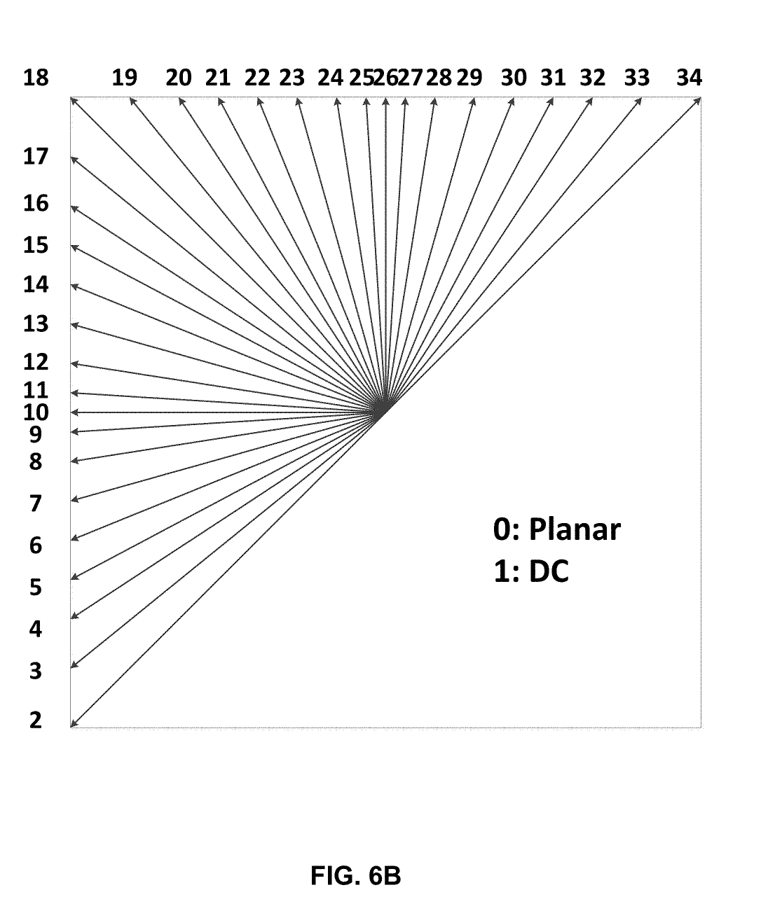

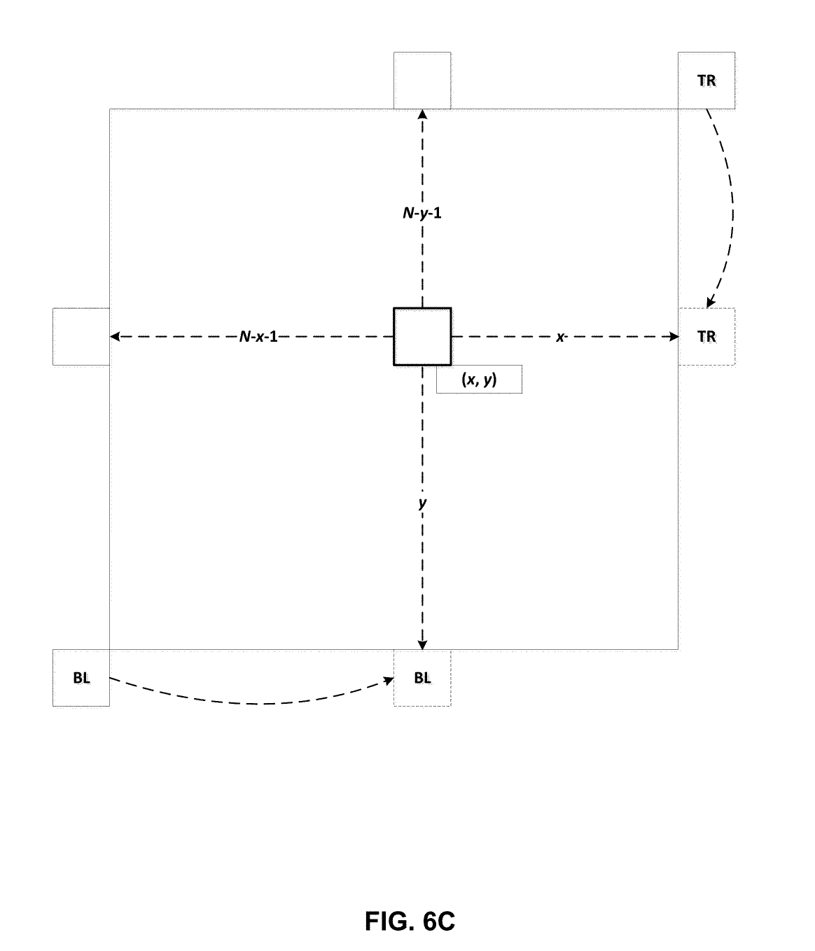

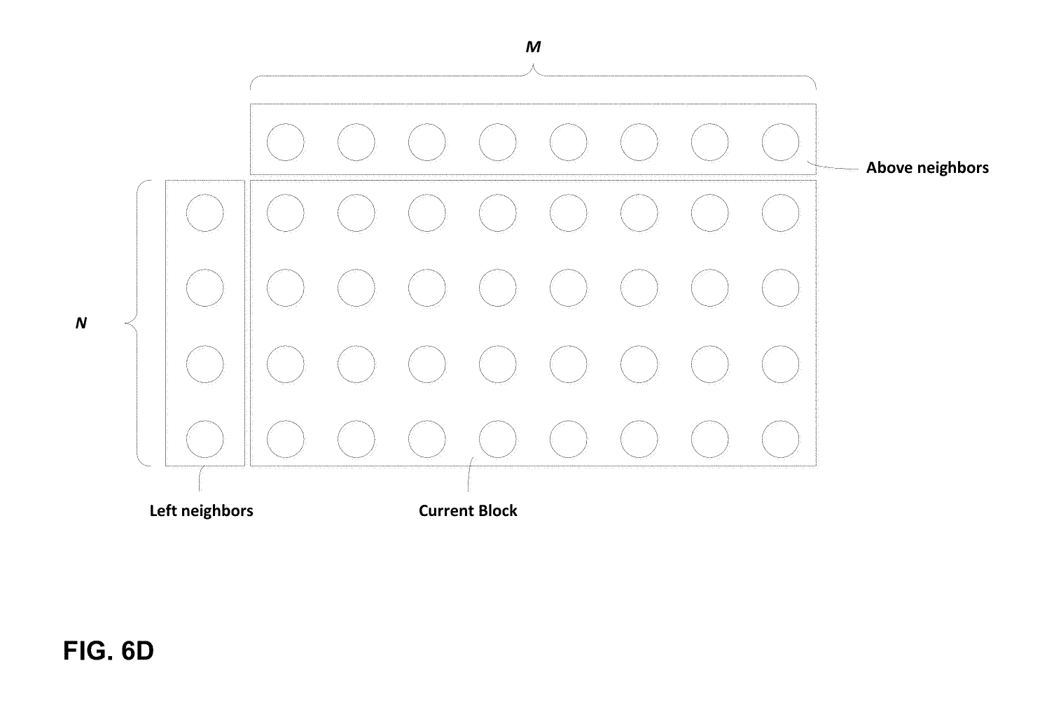

Referring generally to intra prediction, a video coder (e.g., video encoder 22 and/or video decoder 30) may be configured to perform intra prediction. Intra prediction may be described as performing image block prediction using its spatially neighboring reconstructed image samples. FIG. 6A shows an example of intra prediction for a 16×16 block. In the example of FIG. 6A, the 16×16 block (in square 202) is predicted from the above, left and above-left neighboring reconstructed samples (reference samples) located in the above row and left column along a selected prediction direction (as indicated by arrow 204).

In HEVC, intra prediction includes, among others, 35 different modes. The example 35 different modes include Planar mode, DC mode, and 33 angular modes. FIG. 6B illustrates the 33 different angular modes.

For Planar mode, the prediction sample is generated as shown in FIG. 6C. To perform Planar prediction for an N×N block, for each sample p_{xy} located at (x, y), the prediction value is calculated using four specific neighboring reconstructed samples, i.e., reference samples, with bilinear filter. The four reference samples include the top-right reconstructed sample TR, the bottom-left reconstructed sample BL, the reconstructed sample located at the same column (r_{x,-1}) of the current sample denoted by L and the reconstructed sample located at row (r_{-1,y}) of the current sample denoted by T. The planar mode can be formulated as below according to Equation (1):

p_{xy}=((N−x−1)·L+(N−y−1)·T+(x+1)·TR+(y+1)·BL)>>(Log 2(N)+1)

For DC mode, the prediction block is filled with the DC value. In some examples, the DC value may refer to the average value of the neighboring reconstructed samples according to Equation (2):

$${p}_{xy} = DC value = \frac{1}{M + N} ( {\sum }_{k = 0}^{M - 1} {A}_{k} + {\sum }_{k = 0}^{N - 1} {L}_{k} )$$

Referring to equation (2), M is the number of above neighboring reconstructed samples, N is the number of left neighboring reconstructed samples, Aₖ represents the k-th above neighboring reconstructed sample and Lₖ represents the k-th left neighboring reconstructed sample as shown in FIG. 6D. In some examples, when all of the neighboring samples are not available (e.g., not existing or not coded/decoded yet), a default value of 1<<(bitDepth−1) may be assigned to each unavailable sample. In such examples, the variable bitDepth denotes the bit depth of either a luma or chroma component. When a partial number of the neighboring samples are not available, the unavailable samples may be padded by the available samples. Consistent with these examples, M may more broadly refer to the number of above neighboring samples, where the number of above neighboring samples includes one or more reconstructed samples, one or more samples having a default value assigned thereto (e.g., a default value assigned in accordance with 1<<(bitDepth−1)), and/or one or more samples padded by one or more available samples. Similarly, N may also more broadly refer to the number of left neighboring samples, where the number of left neighboring samples includes one or more reconstructed samples, one or more samples having a default value assigned thereto (e.g., a default value assigned in accordance with 1<<(bitDepth−1)), and/or one or more samples padded by one or more available samples. In this regard it is understood that reference to neighboring samples may refer to available neighboring samples and/or unavailable neighboring samples because of the substitution/replacement of values for unavailable neighboring samples. Similarly, Aₖ may thus denote the k-th above neighboring sample; and, if the k-th above neighboring sample is not available, a substitution/replacement value (e.g., a default value or a padded value) may be used instead. Similarly, Lₖ may thus denote the k-th left neighboring sample; and, if the k-th left neighboring sample is not available, a substitution/replacement value (e.g., a default value or a padded value) may be used instead.

The following problems have been observed with some current proposals for coding video data according to intra DC mode prediction. A first problem includes: when the number of total neighboring samples noted as T is not equal to any 2^{k} (where k is an integer), the division operation in the calculation of average value of the neighboring reconstructed samples cannot be replaced by a shifting operation. This is problematic because the division operation imposes a much higher computational complexity than other operations in product design. A second problem includes: A division operation may also occur when some interpolation is needed, but the number of neighboring samples is not equal to a power of 2 (e.g., not equal to any 2^{k}, where k is an integer). For example, reference samples may be linearly interpolated according to the distance from one end to another end (such as when a strong intra filter is applied), and the end samples are used as an input and other samples are interpolated as being in between those end samples. In this example, if the length (e.g., the distance from one end to another end) is not power of 2, a division operation is required.

To address the problems mentioned above, the following techniques are proposed. Video encoder 22 and video decoder 30 may be configured to perform the following techniques. In some examples, video encoder 22 and video decoder 30 may be configured to perform the following techniques in a reciprocal manner. For example, video encoder 22 may be configured to perform the following techniques, and video decoder 30 may be configured to perform the techniques in a reciprocal manner relative to video encoder 22. The following itemized techniques may be applied individually. In addition, each of the following techniques may be used together in any combination. The techniques described below enable the use of a shift operation instead of a division operation thereby reducing computational complexity, thus allowing for greater coding efficiency.

According to one example of the disclosure, when intra DC mode prediction is applied for a block with the size P×Q, where (P+Q) is not a power of 2, video encoder 22 and/or video decoder 30 may derive the DC value using one or more techniques described below. One or more techniques described below may apply when intra DC mode prediction is applied for a block with the size P×Q, where (P+Q) is not a power of 2, and both the left and above neighboring samples are available. In the one or more example techniques described below, equation (2) refers to:

$${p}_{xy} = DC value = \frac{1}{M + N} ( {\sum }_{k = 0}^{M - 1} {A}_{k} + {\sum }_{k = 0}^{N - 1} {L}_{k} ) ,$$

where M is the number of above neighboring reconstructed samples, N is the number of left neighboring reconstructed samples, Aₖ represents the k-th above neighboring reconstructed sample and Lₖ represents the k-th left neighboring reconstructed sample as shown in FIG. 6D. In some examples, when all of the neighboring samples are not available (e.g., not existing or not coded/decoded yet), a default value of 1<<(bitDepth−1) may be assigned to each unavailable sample. In such examples, the variable bitDepth denotes the bit depth of either a luma or chroma component.

When a partial number of the neighboring samples are not available, the unavailable samples may be padded by the available samples. Consistent with these examples, M may more broadly refer to the number of above neighboring samples, where the number of above neighboring samples includes one or more reconstructed samples, one or more samples having a default value assigned thereto (e.g., a default value assigned in accordance with 1<<(bitDepth−1)), and/or one or more samples padded by one or more available samples. Similarly, N may also more broadly refer to the number of left neighboring samples, where the number of left neighboring samples includes one or more reconstructed samples, one or more samples having a default value assigned thereto (e.g., a default value assigned in accordance with 1<<(bitDepth−1)), and/or one or more samples padded by one or more available samples. In this regard it is understood that reference to neighboring samples may refer to available neighboring samples and/or unavailable neighboring samples because of the substitution/replacement of values for unavailable neighboring samples. Similarly, Aₖ may thus denote the k-th above neighboring sample; and, if the k-th above neighboring sample is not available, a substitution/replacement value (e.g., a default value or a padded value) may be used instead. Similarly, Lₖ may thus denote the k-th left neighboring sample; and, if the k-th left neighboring sample is not available, a substitution/replacement value (e.g., a default value or a padded value) may be used instead.

In a first example technique of this disclosure, when using the equation (2) to calculate the DC value, video encoder 22 and/or video decoder 30 may downsample the neighboring samples on the boundary of the longer side (which may be referred to as the long boundary or longer boundary) of a non-square block (e.g., a P×Q block, where P does not equal Q) such that the number of neighboring samples on the downsampled (which may also be referred to as subsampled) boundary is equal to the number of neighboring samples on the shorter boundary (i.e., min(M, N)). In some examples min(M, N) may be equal to min(P, Q). The first example technique includes using the subsampled number of neighboring samples to calculate the DC value instead of the native number of neighboring samples. As used herein for this example as well as other examples, the native number of neighboring samples refers to the number of neighboring samples before any sampling (e.g., downsampling or upsampling) is performed thereon. It is understood that assigning a value to an unavailable neighboring sample does not constitute a sampling process. In some examples, the subsampling process may be a decimation sampling process or an interpolated sampling process. In some examples, the technique of subsampling the neighboring samples on the longer side to equal the number of neighboring samples on the shorter boundary may only be invoked when min(M, N) is a power of 2. In other examples, the technique of sub sampling the neighboring samples on the longer side to equal the number of neighboring samples on the shorter boundary may only be invoked when min(P, Q) is a power of 2.

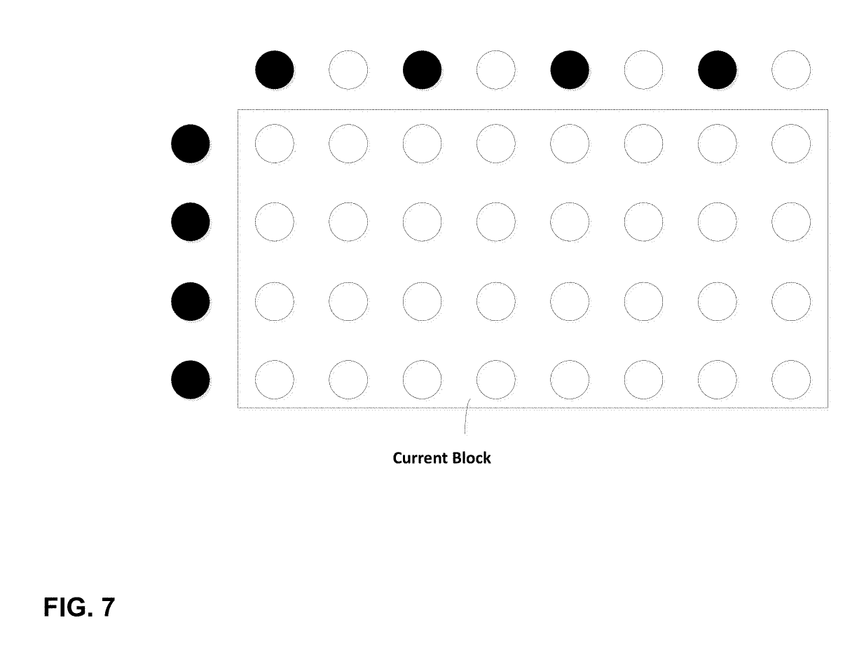

FIG. 7 shows an example technique of subsampling neighboring samples on the boundary of the longer side using a division-free DC value calculation technique described herein. In the example of FIG. 7, the black samples are involved to calculate the DC value; and, as shown, the neighboring samples on the longer side are subsampled from 8 neighboring samples to 4 neighboring samples. Further described, FIG. 7 shows an example of the first example technique, where P equals 8 and Q equals 4 in a P×Q block. In the example of FIG. 7, the neighboring samples on the longer side of the P×Q block are shown as being subsampled according to a decimation sampling process before calculating the DC value, meaning that the subsampled number of neighboring samples is used in calculating the DC value instead of the native number of neighboring samples. In the P×Q block example of FIG. 7, M is equal to 8 and N is equal to 4, and M is depicted as being subsampled such that the number of above neighboring samples is equal to the number of samples on the shorter boundary, which is 4 in this example. Further described, the subsampled number of neighboring samples includes 8 neighboring samples (the 4 native left neighboring samples and the 4 subsampled above neighboring samples), and the native number of neighboring samples includes 12 neighboring samples (8 native above neighboring samples and 4 native left neighboring samples).

According to an example different from the example depicted in FIG. 7, video encoder 22 and/or video decoder 30 may upsample neighboring samples located at both the longer and shorter sides of the P×Q block. In some examples, the subsampling ratio on the longer side may be different from the subsampling ratio on the shorter side. In some examples, the total number of neighboring samples at the shorter and longer sides after downsampling may be required to be equal to a power of 2, which may be described as 2^{k} where k is an integer. In some examples, the value of k may be dependent on the block size of P×Q. For example, the value of k may be dependent on the values of P and/or Q. For example, the value of k may be equal to the absolute value of (P−Q). In some examples, the technique of subsampling the neighboring samples on the shorter boundary and/or the longer boundary may only be invoked when min(M, N) is a power of 2. In other examples, the technique of subsampling the neighboring samples on the shorter boundary and/or the longer boundary may only be invoked when min(P, Q) is a power of 2.

In a second example technique of this disclosure, when using the equation (2) to calculate the DC value, video encoder 22 and/or video decoder 30 may upsample the neighboring samples on the boundary of the shorter side (which may be referred to as the short boundary or the shorter boundary) of a non-square block (e.g., a P×Q block, where P does not equal Q) such that the number of neighboring samples on the upsampled boundary is equal to the number of neighboring samples on the longer boundary (i.e., max(M, N)). In some examples max(M N) may be equal to max(P, Q). The second example technique includes using the upsampled number of neighboring samples to calculate the DC value instead of the native number of neighboring samples. In some examples, the upsampling process may be a duplicator sampling process or an interpolated sampling process. In some examples, the technique of upsampling the neighboring samples on the shorter side to equal the number of neighboring samples on the longer boundary may only be invoked when max(M, N) is a power of 2. In other examples, the technique of upsampling the neighboring samples on the shorter side to equal the number of neighboring samples on the longer boundary may only be invoked when max(P, Q) is a power of 2.

In other examples, video encoder 22 and/or video decoder 30 may upsample neighboring samples located at both the longer and shorter sides of the P×Q block. In some examples, the upsampling ratio on the longer side may be different from the sub sampling ratio on the shorter side. In some examples, the total number of neighboring samples at the shorter and longer sides after upsampling may be required to be equal to a power of 2, which may be described as 2^{k} where k is an integer. In some examples, the value of k may be dependent on the block size of P×Q. For example, the value of k may be dependent on the values of P and/or Q. For example, the value of k may be equal to the absolute value of (P−Q). In some examples, the technique of upsampling the neighboring samples on the shorter boundary and/or the longer boundary may only be invoked when max(M, N) is a power of 2. In other examples, the technique of upsampling the neighboring samples on the shorter boundary and/or the longer boundary may only be invoked when max(P, Q) is a power of 2.

In a third example technique of this disclosure, when using the equation (2) to calculate the DC value, video encoder 22 and/or video decoder 30 may upsample the neighboring samples on the boundary of the shorter side (which may be referred to as the short boundary or the shorter boundary) of a non-square block (e.g., a P×Q block, where P does not equal Q) and downsample the neighboring samples on the boundary of the longer side (which may be referred to as the long boundary or the longer boundary) such that the number of neighboring samples on the upsampled shorter boundary is equal to the number of neighboring samples on the subsampled longer boundary. In some examples, the upsampling process may be a duplicator sampling process or an interpolated sampling process. In some examples, the subsampling process may be a decimation sampling process or an interpolated sampling process. In some examples, the total number of neighboring samples after subsampling and upsampling may be required to a power of 2, which may be described as 2^{k} where k is an integer. In some examples, the value of k may be dependent on the block size of P×Q. For example, the value of k may be dependent on the values of P and/or Q. For example, the value of k may be equal to the absolute value of (P−Q).

In a fourth example technique of this disclosure, video encoder 22 and/or video decoder 30 may apply different ways of subsampling and/or upsampling neighboring samples. In one example, the subsampling and/or upsampling process(es) may be dependent on the block size (e.g., the values of P and/or Q of a block having the size of P×Q). In some examples, the block size may correspond to a prediction unit size because the block is a prediction unit. In another example, the subsampling and/or upsampling process(es) may be signaled by video encoder 22 in at least one of: a sequence parameter set, a picture parameter set, a video parameter set, an adaption parameter set, a picture header, or a slice header.

In a fifth example technique of this disclosure, video encoder 22 and/or video decoder 30 may downsample both sides (e.g., the shorter side and the longer side) so that the number of neighboring samples on both downsampled boundaries is equal to the largest value which is a power of 2, where the largest value is a common multiple of the two sides. No change on a side may be regarded as a special downsampling in which the downsampling factor is 1. In another example, both sides (e.g., the shorter side and the longer side) may be downsampled so that the number of neighboring samples on both downsampled boundaries are equal to a largest common multiple between the two sides. In some examples, the largest common multiple between the two sides may be required to be a power of 2. For example, in an example where a block has the size of 8×4, the largest common multiple between the two sides is 4, and 4 is also a power of 2. In this example, the downsampling factor for the shorter side of 4 may be equal to 1 and the downsampling factor for the longer side of 8 may be equal to 2.

In a sixth example technique of this disclosure, video encoder 22 and/or video decoder 30 may upsample both sides (e.g., the shorter side and the longer side) so that the number of neighboring samples on both upsampled boundaries is equal to the smallest value which is a power of 2, where the smallest value is a common multiple of the two sides. No change on a side may be regarded as a special upsampling in which the upsampling factor is 1. In another example, both sides (e.g., the shorter side and the longer side) may be upsampled so that the number of neighboring samples on both upsampled boundaries are equal to a smallest common multiple between the two sides. In some examples, the smallest common multiple between the two sides may be required to be a power of 2. For example, in an example where a block has the size of 8×4, the smallest common multiple between the two sides is 8, and 8 is also a power of 2. In this example, the upsampling factor for the longer side of 8 may be equal to 1 and the upsampling factor for the shorter side of 4 may be equal to 2.

In a seventh example technique of this disclosure, instead of using equation (2) to calculate the DC value, video encoder 22 and/or video decoder 30 may calculate the DC value as the average value of the longer side of neighboring samples as follows according to equation (3) or equation (4):

$$\begin{matrix}DC value = \{ \begin{matrix}\frac{1}{M} {\sum }_{k = 0}^{M - 1} {A}_{k} , if M > N \\ \frac{1}{N} {\sum }_{k = 0}^{N - 1} {L}_{k} , if M < N\end{matrix} , \\ or & Equation ( 3 ) \\ DC value = \{ \begin{matrix}( ( {\sum }_{k = 0}^{M - 1} {A}_{k} ) + off 1 ) >> m , if M > N \\ ( ( {\sum }_{k = 0}^{N - 1} {L}_{k} ) + off 2 ) >> n , if M < N\end{matrix} & Equation ( 4 )\end{matrix}$$

In an eighth example technique of this disclosure, instead of using equation (2) to calculate the DC value, video encoder 22 and/or video decoder 30 may calculate the DC value as the average value of the two average values of the two side neighboring samples as follows according to equation (5) or equation (6):

$$\begin{matrix} DC value = \frac{1}{2} ( \frac{1}{M} {\sum }_{k = 0}^{M - 1} {A}_{k} + \frac{1}{N} {\sum }_{k = 0}^{N - 1} {L}_{k} ) , \\ or & Equation ( 5 ) \\ DC value = ( ( ( off 1 + {\sum }_{k = 0}^{M - 1} {A}_{k} ) >> m ) + ( off 2 + ( {\sum }_{k = 0}^{N - 1} {L}_{k} ) >> n ) + off 3 ) >> 1 & Equation ( 6 )\end{matrix}$$

In equations (3), (4), (5), and (6), the variables M, N, Aₖ, and Lₖ may be defined in the same manner as for equation (2) above. The variable of f1 may be an integer, such as 0 or (1<<(m−1)). The variable of f2 may be an integer, such as 0 or (1<<(n−1)).

In a ninth example technique of this disclosure, instead of using equation (2) to calculate the DC value, video encoder 22 and/or video decoder 30 may calculate the DC value as follows according to equation (7) or equation (8):

$$\begin{matrix}DC value = \{ \begin{matrix}\frac{1}{2 M} ( {\sum }_{k = 0}^{M - 1} {A}_{k} + S \times {\sum }_{k = 0}^{N - 1} {L}_{k} ) , if M > N , where S = M \text{/} N \\ \frac{1}{2 N} ( S \times {\sum }_{k = o}^{M - 1} {A}_{k} + {\sum }_{k = 0}^{N - 1} {L}_{k} ) , if M < N , where S = N \text{/} M\end{matrix} , \\ or & Equation ( 7 ) \\ DC value = \{ \begin{matrix}( ( {\sum }_{k = 0}^{M - 1} {A}_{k} ) + ( ( {\sum }_{k = 0}^{N - 1} {L}_{k} ) << ( m - n ) ) + off 1 ) >> ( m + 1 ) , if M > N \\ ( ( ( {\sum }_{k = 0}^{M - 1} {A}_{k} ) << ( n - m ) ) + ( {\sum }_{k = 0}^{N - 1} {L}_{k} ) + off 2 ) >> ( n + 1 ) , if M < N\end{matrix} & Equation ( 8 )\end{matrix}$$

In equations (7) and (8), the variables M, N, Aₖ, and Lₖ may be defined in the same manner as for equation (2) above. The variable of f1 may be an integer, such as 0 or (1<<m). The variable of f2 may be an integer, such as 0 or (1<<n).

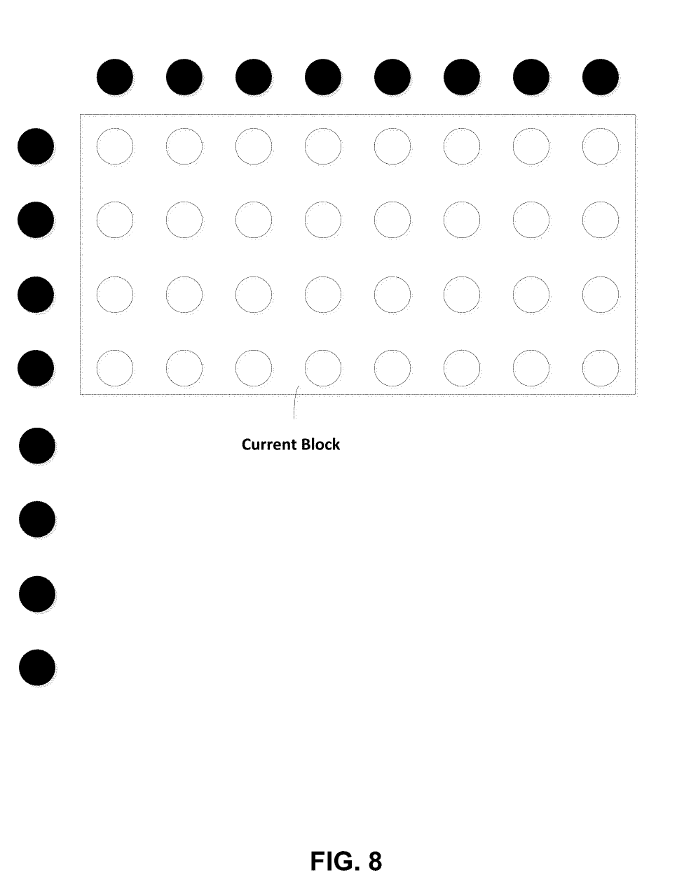

In a tenth example technique of this disclosure, when using equation (2) to calculate the DC value, video encoder 22 and/or video decoder 30 may extend the neighboring samples on the boundary of the shorter side of the current block (e.g., the non-square block having a size of P×Q). FIG. 8 illustrates one example in accordance with the tenth example technique. For example, FIG. 8 shows an example of extending the neighboring samples on the boundary of the shorter side using a division-free DC value calculation technique described herein. In the example of FIG. 8, the black samples are involved to calculate the DC value; and, as shown, the shorter side neighboring boundary is extended in an example manner. In some examples, it may be required that the total number of neighboring samples at the two sides after the one side being extended be equal to a power of 2, which may be described as 2^{k} where k is an integer. In some examples, the value of k may be dependent on the block size of P×Q. For example, the value of k may be dependent on the values of P and/or Q. For example, the value of k may be equal to the absolute value of (P−Q).

In an eleventh example technique of this disclosure, if one or more extended neighboring samples in the example techniques involving extended neighboring samples are not available, video encoder 22 and/or video decoder 30 may pad the one or more unavailable extended neighboring samples. In some examples, the one or more unavailable extended neighboring samples may be padded (i) by the available neighboring samples, (ii) by mirroring the one or more unavailable extended neighboring samples from the available neighboring samples.

In a twelfth example technique of this disclosure, video encoder 22 and/or video decoder 30 may apply a lookup table with entries based on the block or transform sizes supported by a codec when using equation (2) to calculate the DC value to avoid the division operation.

In a thirteenth example technique of this disclosure, if the left side of a current block (e.g., the non-square block having a size of P×Q) is the short side and one or more of the left neighboring samples are unavailable, video encoder 22 and/or video decoder 30 may use one or more samples located two columns to the left of the current block to replace/substitute the one or more unavailable left neighboring samples. In some examples, the one or more left neighboring samples that are unavailable are bottom-left neighboring samples. Similarly, if the top side of the current block is the short side and one or more of the top samples are unavailable, video encoder 22 and/or video decoder 30 may use one or more samples located two rows above the current block to replace/substitute the one or more unavailable above-neighboring samples. In some examples, the one or more above neighboring samples that are unavailable are above-right neighboring samples. In some examples, it may be required that the total number of neighboring samples at the left and top sides after replacement/substitution of one or more unavailable neighboring samples be equal to a power of 2, which may be described as 2^{k} where k is an integer. In some examples, the value of k may be dependent on the block size of P×Q. For example, the value of k may be dependent on the values of P and/or Q. For example, the value of k may be equal to the absolute value of (P−Q).

In a fourteenth example technique of this disclosure, video encoder 22 and/or video decoder 30 may use a weighted average instead of a simple average where the sum of the weights may be equal to a power of 2, which may be described as 2^{k} where k is an integer. In some examples, the weights may be based on metrics that indicate the quality of neighboring samples. For example, one or more weights may be based on one or more of the following metrics: a QP value, a transform size, a prediction mode, or the total number of bits spent on the residual coefficients of the neighboring block. In some examples, greater values may be placed on samples that have better quality metrics. In accordance with the fourteenth example technique, instead of using equation (2) to calculate the DC value, the DC value may be calculated as follows according to equation (9):

$$DC value = ( {\sum }_{m = 0}^{M - 1} {w}_{A , m} {A}_{m} + {\sum }_{n = 0}^{N - 1} {w}_{L , n} {L}_{n} + offset ) >> k$$

$$offset = {2}^{k - 1}$$

$${\sum }_{m = 0}^{M - 1} {w}_{A , m} + {\sum }_{n = 0}^{N - 1} {w}_{L , n} = {2}^{k}$$

In some examples, a pre-defined set of weighting factors may be stored and video encoder 22 may be configured signal the set index via SPS, PPS, VPS, or the slice header.

In a fifteenth example technique of this disclosure, some examples are disclosed regarding how to avoid a division operation if the current block width or height is not equal to a power of 2. These examples are not limited to a strong intra filter; instead, the examples described herein may be applied in any other case in which a similar problem arises. When division by a distance (width or height) is needed, and the distance is not power of 2, the following three different aspects may be applied separately or in any combination.

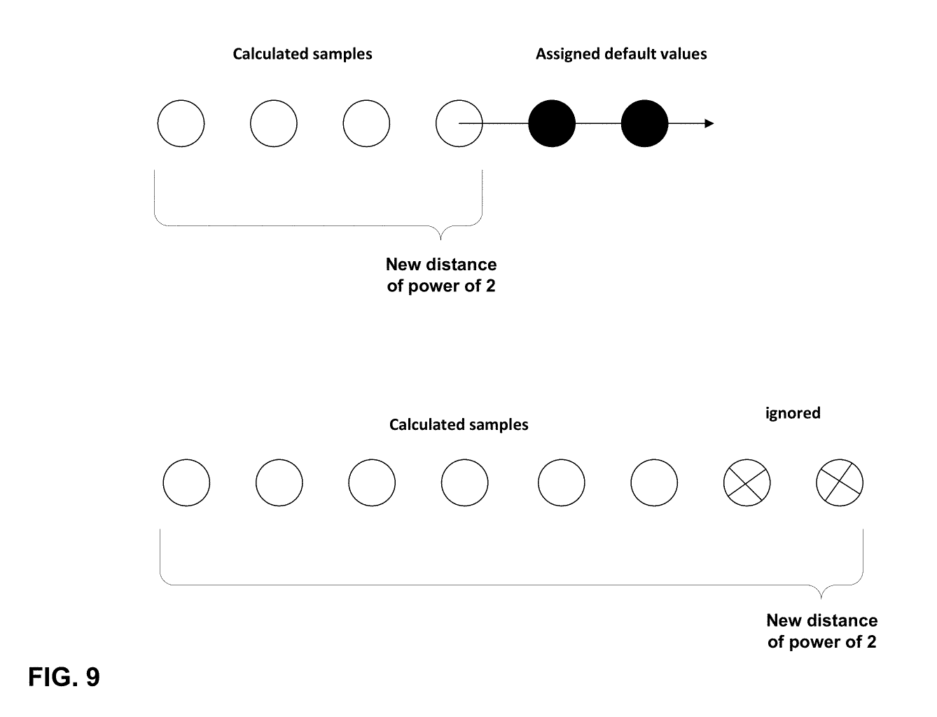

In a first aspect of the fifteenth example technique of this disclosure, video encoder 22 and/or video decoder 30 may round an initial distance to be used for division to the nearest distance that is a power of 2. In some examples, the initial distance may be referred to as the actual distance because the initial distance may refer to the distance before any rounding occurs. The rounded distance may be smaller or larger than the initial distance. When neighboring samples are calculated up to the new rounded distance, the division operation may be replaced by a shift operation since the new rounded distance is power of 2. In some examples, if the new rounded distance is smaller than the initial distance, the neighboring samples located in the position exceeding the new rounded distance may be assigned a default value such as in the top example shown in FIG. 9. In the top example of FIG. 9, the initial distance is equal to 6 and the new rounded distance is 4. In this example, the neighboring samples located in the position exceeding the new rounded distance are depicted as being assigned a default value. In some examples, the default value assigned may include the value of the last calculated sample (e.g., the last calculated sample may be repeated), or the average value of the calculated samples may be assigned. In other examples, if the new rounded distance is larger than the initial distance, the number of calculated neighboring samples may be greater than is required, and some neighboring samples may be ignored, such as in the bottom example shown in FIG. 9. In the bottom example of FIG. 9, the initial distance is equal to 6 and the new rounded distance is 8. In this example, the neighboring samples exceeding the initial distance of 6 are depicted as being ignored.

In a second aspect of the fifteenth example technique of this disclosure, video encoder 22 and/or video decoder 30 may not apply a coding technique (e.g., a strong intra prediction filter or other tool) for a direction (e.g., horizontal or vertical) of a current block if the division operation is required for that direction. Otherwise described, a coding technique (e.g., a strong intra prediction filter or other tool) may be applied for a current block only if the division can be represented as a shift operation.

In a third aspect of the fifteenth example technique of this disclosure, video encoder 22 and/or video decoder 30 may use a recursive calculation. In this aspect, the initial distance may be rounded to the nearest, smallest distance that is a power of 2. For example, if the initial distance is 6, the value of 6 would be rounded to 4 instead of 8 since the value of 4 is the nearest, smallest distance that is a power of 2. Neighboring samples may be calculated up to the new rounded distance. When the process repeats, the last calculated neighboring sample may be used as the first neighboring sample, and the initial distance may be reduced by the rounded smallest distance. The process may be terminated when the reduced distance is equal to 1. The techniques of this disclosure also contemplate any combination of features or techniques set forth in the different examples discussed above.

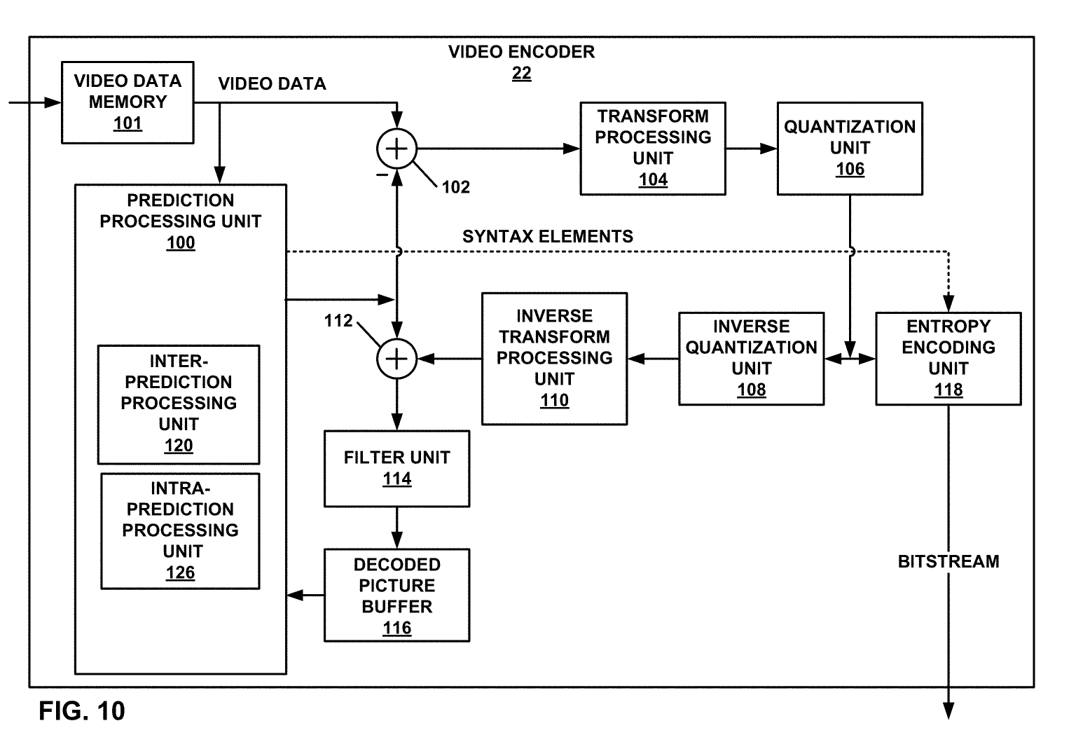

FIG. 10 is a block diagram illustrating an example video encoder 22 that may implement the techniques of this disclosure. FIG. 10 is provided for purposes of explanation and should not be considered limiting of the techniques as broadly exemplified and described in this disclosure. The techniques of this disclosure may be applicable to various coding standards or methods.

In the example of FIG. 10, video encoder 22 includes a prediction processing unit 100, video data memory 101, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Prediction processing unit 100 includes an inter-prediction processing unit 120 and an intra-prediction processing unit 126. Inter-prediction processing unit 120 may include a motion estimation unit and a motion compensation unit (not shown).

Video data memory 101 may be configured to store video data to be encoded by the components of video encoder 22. The video data stored in video data memory 101 may be obtained, for example, from video source 18. Decoded picture buffer 116 may be a reference picture memory that stores reference video data for use in encoding video data by video encoder 22, e.g., in intra- or inter-coding modes. Video data memory 101 and decoded picture buffer 116 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 101 and decoded picture buffer 116 may be provided by the same memory device or separate memory devices. In various examples, video data memory 101 may be on-chip with other components of video encoder 22, or off-chip relative to those components. Video data memory 101 may be the same as or part of storage media 20 of FIG. 1.

Video encoder 22 receives video data. Video encoder 22 may encode each CTU in a slice of a picture of the video data. Each of the CTUs may be associated with equally-sized luma CTBs and corresponding CTBs of the picture. As part of encoding a CTU, prediction processing unit 100 may perform partitioning to divide the CTBs of the CTU into progressively-smaller blocks. The smaller blocks may be coding blocks of CUs. For example, prediction processing unit 100 may partition a CTB associated with a CTU according to a tree structure. In accordance with one or more techniques of this disclosure, for each respective non-leaf node of the tree structure at each depth level of the tree structure, there are a plurality of allowed splitting patterns for the respective non-leaf node and the video block corresponding to the respective non-leaf node is partitioned into video blocks corresponding to the child nodes of the respective non-leaf node according to one of the plurality of allowable splitting patterns. In one example, prediction processing unit 100 or another processing unit of video encoder 22 may be configured to perform any combination of the techniques described herein.

Video encoder 22 may encode CUs of a CTU to generate encoded representations of the CUs (i.e., coded CUs). As part of encoding a CU, prediction processing unit 100 may partition the coding blocks associated with the CU among one or more PUs of the CU. In accordance with techniques of this disclosure, a CU may only include a single PU. That is, in some examples of this disclosure, a CU is not divided into separate prediction blocks, but rather, a prediction process is performed on the entire CU. Thus, each CU may be associated with a luma prediction block and corresponding chroma prediction blocks. Video encoder 22 and video decoder 30 may support CUs having various sizes. As indicated above, the size of a CU may refer to the size of the luma coding block of the CU also the size of a luma prediction block. As discussed above, video encoder 22 and video decoder 30 may support CU sizes defined by any combination of the example partitioning techniques described herein.

Inter-prediction processing unit 120 may generate predictive data for a PU by performing inter prediction on each PU of a CU. As explained herein, in some examples of this disclosure, a CU may contain only a single PU, that is, the CU and PU may be synonymous. The predictive data for the PU may include predictive blocks of the PU and motion information for the PU. Inter-prediction processing unit 120 may perform different operations for a PU or a CU depending on whether the PU is in an I slice, a P slice, or a B slice. In an I slice, all PUs are intra predicted. Hence, if the PU is in an I slice, inter-prediction processing unit 120 does not perform inter prediction on the PU. Thus, for blocks encoded in I-mode, the predicted block is formed using spatial prediction from previously-encoded neighboring blocks within the same frame. If a PU is in a P slice, inter-prediction processing unit 120 may use uni-directional inter prediction to generate a predictive block of the PU. If a PU is in a B slice, inter-prediction processing unit 120 may use uni-directional or bi-directional inter prediction to generate a predictive block of the PU.

Intra-prediction processing unit 126 may generate predictive data for a PU by performing intra prediction on the PU. The predictive data for the PU may include predictive blocks of the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. Intra-prediction processing unit 126 may use samples from sample blocks of neighboring PUs to generate a predictive block for a PU. The neighboring PUs may be above, above and to the right, above and to the left, or to the left of the PU, assuming a left-to-right, top-to-bottom encoding order for PUs, CUs, and CTUs. Intra-prediction processing unit 126 may use various numbers of intra prediction modes, e.g., 33 directional intra prediction modes. In some examples, the number of intra prediction modes may depend on the size of the region associated with the PU.

Prediction processing unit 100 may select the predictive data for PUs of a CU from among the predictive data generated by inter-prediction processing unit 120 for the PUs or the predictive data generated by intra-prediction processing unit 126 for the PUs. In some examples, prediction processing unit 100 selects the predictive data for the PUs of the CU based on rate/distortion metrics of the sets of predictive data. The predictive blocks of the selected predictive data may be referred to herein as the selected predictive blocks.

Residual generation unit 102 may generate, based on the coding blocks (e.g., luma, Cb and Cr coding blocks) for a CU and the selected predictive blocks (e.g., predictive luma, Cb and Cr blocks) for the PUs of the CU, residual blocks (e.g., luma, Cb and Cr residual blocks) for the CU. For instance, residual generation unit 102 may generate the residual blocks of the CU such that each sample in the residual blocks has a value equal to a difference between a sample in a coding block of the CU and a corresponding sample in a corresponding selected predictive block of a PU of the CU.

Transform processing unit 104 may perform quad-tree partitioning to partition the residual blocks associated with a CU into transform blocks associated with TUs of the CU. Thus, a TU may be associated with a luma transform block and two chroma transform blocks. The sizes and positions of the luma and chroma transform blocks of TUs of a CU may or may not be based on the sizes and positions of prediction blocks of the PUs of the CU. A quad-tree structure known as a “residual quad-tree” (RQT) may include nodes associated with each of the regions. The TUs of a CU may correspond to leaf nodes of the RQT. In other examples, transform processing unit 104 may be configured to partition TUs in accordance with the partitioning techniques described herein. For example, video encoder 22 may not further divide CUs into TUs using an RQT structure. As such, in one example, a CU includes a single TU.

Transform processing unit 104 may generate transform coefficient blocks for each TU of a CU by applying one or more transforms to the transform blocks of the TU. Transform processing unit 104 may apply various transforms to a transform block associated with a TU. For example, transform processing unit 104 may apply a discrete cosine transform (DCT), a directional transform, or a conceptually similar transform to a transform block. In some examples, transform processing unit 104 does not apply transforms to a transform block. In such examples, the transform block may be treated as a transform coefficient block.

Quantization unit 106 may quantize the transform coefficients in a coefficient block. The quantization process may reduce the bit depth associated with some or all of the transform coefficients. For example, an n-bit transform coefficient may be rounded down to an m-bit transform coefficient during quantization, where n is greater than m. Quantization unit 106 may quantize a coefficient block associated with a TU of a CU based on a quantization parameter (QP) value associated with the CU. Video encoder 22 may adjust the degree of quantization applied to the coefficient blocks associated with a CU by adjusting the QP value associated with the CU. Quantization may introduce loss of information. Thus, quantized transform coefficients may have lower precision than the original ones.

Inverse quantization unit 108 and inverse transform processing unit 110 may apply inverse quantization and inverse transforms to a coefficient block, respectively, to reconstruct a residual block from the coefficient block. Reconstruction unit 112 may add the reconstructed residual block to corresponding samples from one or more predictive blocks generated by prediction processing unit 100 to produce a reconstructed transform block associated with a TU. By reconstructing transform blocks for each TU of a CU in this way, video encoder 22 may reconstruct the coding blocks of the CU.

Filter unit 114 may perform one or more deblocking operations to reduce blocking artifacts in the coding blocks associated with a CU. Decoded picture buffer 116 may store the reconstructed coding blocks after filter unit 114 performs the one or more deblocking operations on the reconstructed coding blocks. Inter-prediction processing unit 120 may use a reference picture that contains the reconstructed coding blocks to perform inter prediction on PUs of other pictures. In addition, intra-prediction processing unit 126 may use reconstructed coding blocks in decoded picture buffer 116 to perform intra prediction on other PUs in the same picture as the CU.

Entropy encoding unit 118 may receive data from other functional components of video encoder 22. For example, entropy encoding unit 118 may receive coefficient blocks from quantization unit 106 and may receive syntax elements from prediction processing unit 100. Entropy encoding unit 118 may perform one or more entropy encoding operations on the data to generate entropy-encoded data. For example, entropy encoding unit 118 may perform a CABAC operation, a context-adaptive variable length coding (CAVLC) operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 22 may output a bitstream that includes entropy-encoded data generated by entropy encoding unit 118. For instance, the bitstream may include data that represents the partition structure for a CU according to the techniques of this disclosure.

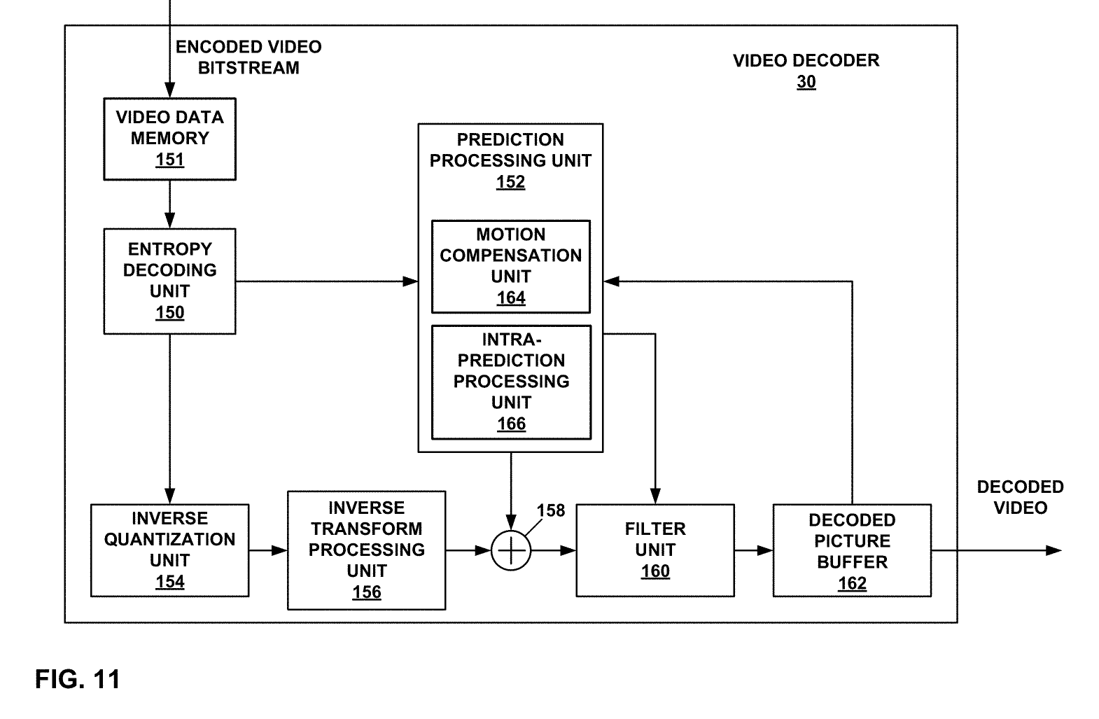

FIG. 11 is a block diagram illustrating an example video decoder 30 that is configured to implement the techniques of this disclosure. FIG. 11 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 11, video decoder 30 includes an entropy decoding unit 150, video data memory 151, a prediction processing unit 152, an inverse quantization unit 154, an inverse transform processing unit 156, a reconstruction unit 158, a filter unit 160, and a decoded picture buffer 162. Prediction processing unit 152 includes a motion compensation unit 164 and an intra-prediction processing unit 166. In other examples, video decoder 30 may include more, fewer, or different functional components.

Video data memory 151 may store encoded video data, such as an encoded video bitstream, to be decoded by the components of video decoder 30. The video data stored in video data memory 151 may be obtained, for example, from computer-readable medium 16, e.g., from a local video source, such as a camera, via wired or wireless network communication of video data, or by accessing physical data storage media. Video data memory 151 may form a coded picture buffer (CPB) that stores encoded video data from an encoded video bitstream. Decoded picture buffer 162 may be a reference picture memory that stores reference video data for use in decoding video data by video decoder 30, e.g., in intra- or inter-coding modes, or for output. Video data memory 151 and decoded picture buffer 162 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 151 and decoded picture buffer 162 may be provided by the same memory device or separate memory devices. In various examples, video data memory 151 may be on-chip with other components of video decoder 30, or off-chip relative to those components. Video data memory 151 may be the same as or part of storage media 28 of FIG. 1.

Video data memory 151 receives and stores encoded video data (e.g., NAL units) of a bitstream. Entropy decoding unit 150 may receive encoded video data (e.g., NAL units) from video data memory 151 and may parse the NAL units to obtain syntax elements. Entropy decoding unit 150 may entropy decode entropy-encoded syntax elements in the NAL units. Prediction processing unit 152, inverse quantization unit 154, inverse transform processing unit 156, reconstruction unit 158, and filter unit 160 may generate decoded video data based on the syntax elements extracted from the bitstream. Entropy decoding unit 150 may perform a process generally reciprocal to that of entropy encoding unit 118.

In accordance with some examples of this disclosure, entropy decoding unit 150, or another processing unit of video decoder 30, may determine a tree structure as part of obtaining the syntax elements from the bitstream. The tree structure may specify how an initial video block, such as a CTB, is partitioned into smaller video blocks, such as coding units. In accordance with one or more techniques of this disclosure, for each respective non-leaf node of the tree structure at each depth level of the tree structure, there are a plurality of allowed partition types for the respective non-leaf node and the video block corresponding to the respective non-leaf node is partitioned into video blocks corresponding to the child nodes of the respective non-leaf node according to one of the plurality of allowable splitting patterns.

In addition to obtaining syntax elements from the bitstream, video decoder 30 may perform a reconstruction operation on a non-partitioned CU. To perform the reconstruction operation on a CU, video decoder 30 may perform a reconstruction operation on each TU of the CU. By performing the reconstruction operation for each TU of the CU, video decoder 30 may reconstruct residual blocks of the CU. As discussed above, in one example of the disclosure, a CU includes a single TU.

As part of performing a reconstruction operation on a TU of a CU, inverse quantization unit 154 may inverse quantize, i.e., de-quantize, coefficient blocks associated with the TU. After inverse quantization unit 154 inverse quantizes a coefficient block, inverse transform processing unit 156 may apply one or more inverse transforms to the coefficient block in order to generate a residual block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If a CU or PU is encoded using intra prediction, intra-prediction processing unit 166 may perform intra prediction to generate predictive blocks of the PU. Intra-prediction processing unit 166 may use an intra prediction mode to generate the predictive blocks of the PU based on samples spatially-neighboring blocks. Intra-prediction processing unit 166 may determine the intra prediction mode for the PU based on one or more syntax elements obtained from the bitstream.

If a PU is encoded using inter prediction, entropy decoding unit 150 may determine motion information for the PU. Motion compensation unit 164 may determine, based on the motion information of the PU, one or more reference blocks. Motion compensation unit 164 may generate, based on the one or more reference blocks, predictive blocks (e.g., predictive luma, Cb and Cr blocks) for the PU. As discussed above, a CU may include only a single PU. That is, a CU may not be divided into multiple PUs.

Reconstruction unit 158 may use transform blocks (e.g., luma, Cb and Cr transform blocks) for TUs of a CU and the predictive blocks (e.g., luma, Cb and Cr blocks) of the PUs of the CU, i.e., either intra-prediction data or inter-prediction data, as applicable, to reconstruct the coding blocks (e.g., luma, Cb and Cr coding blocks) for the CU. For example, reconstruction unit 158 may add samples of the transform blocks (e.g., luma, Cb and Cr transform blocks) to corresponding samples of the predictive blocks (e.g., luma, Cb and Cr predictive blocks) to reconstruct the coding blocks (e.g., luma, Cb and Cr coding blocks) of the CU.

Filter unit 160 may perform a deblocking operation to reduce blocking artifacts associated with the coding blocks of the CU. Video decoder 30 may store the coding blocks of the CU in decoded picture buffer 162. Decoded picture buffer 162 may provide reference pictures for subsequent motion compensation, intra prediction, and presentation on a display device, such as display device 32 of FIG. 1. For instance, video decoder 30 may perform, based on the blocks in decoded picture buffer 162, intra prediction or inter prediction operations for PUs of other CUs.

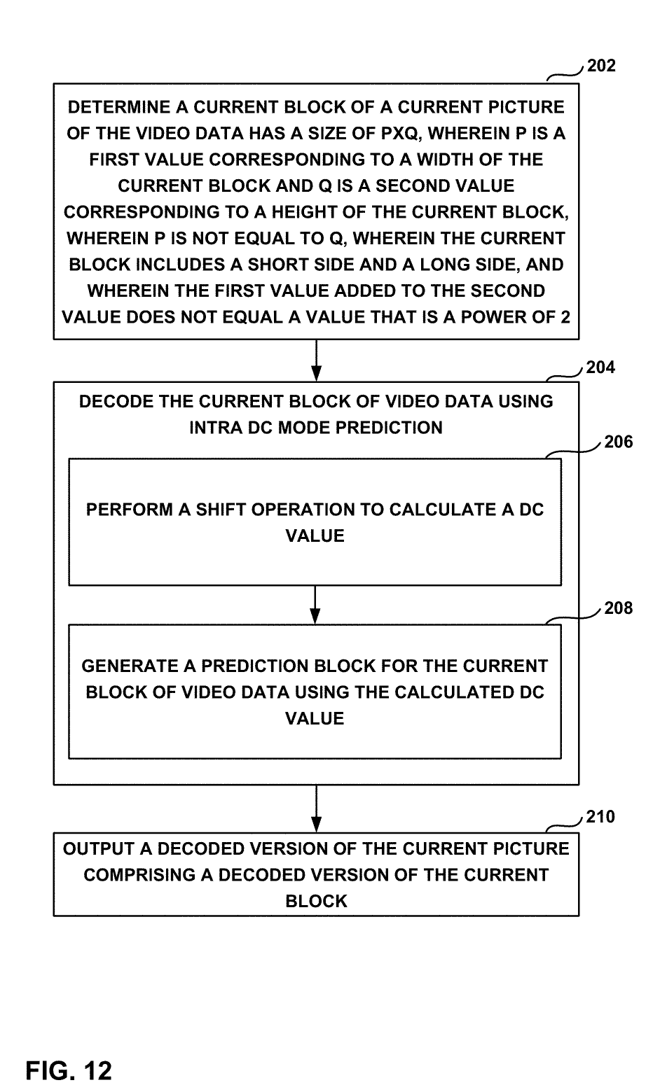

FIG. 12 is a flowchart illustrating an example operation of a video decoder for decoding video data in accordance with a technique of this disclosure. The video decoder described with respect to FIG. 12 may, for example, be a video decoder, such as video decoder 30, for outputting displayable decoded video or may be a video decoder implemented in a video encoder, such as the decoding loop of video encoder 22, a portion of which includes prediction processing unit 100 and summer 112.

In accordance with the techniques of FIG. 12, the video decoder determines a current block of a current picture of the video data has a size of P×Q, with P being a first value corresponding to a width of the current block and Q being a second value corresponding to a height of the current block (202). P is not equal to Q such that the current block includes a short side and a long side, and the first value added to the second value does not equal a value that is a power of 2. The video decoder decodes the current block of video data using intra DC mode prediction (204). To decode the current block of video data using intra DC mode prediction, the video decoder performs a shift operation to calculate a DC value (206) and generates a prediction block for the current block of video data using the calculated DC value (208).

In one example, to decode the current block of video data using intra DC mode prediction, the video decoder determines a first average sample value for the samples neighboring the short side using the shift operation, determines a second average value for the samples neighboring the long side using the shift operation, and calculates the DC value by determining an average value of the first average value and the second average value using the shift operation. To determine the average value of the first average value and the second average value, the video decoder may determine a weighted average value of the first average value and the second average value. In another example, to decode the current block of video data using intra DC mode prediction, the video decoder downsamples the number of samples neighboring the long side to determine a number of downsampled samples neighboring the long side such that the number of downsampled samples neighboring the long side and the number of samples neighboring the short side combined equals a value that is a power of 2. In another example, to decode the current block of video data using intra DC mode prediction, the video decoder upsamples the number of samples neighboring the short side to determine a number of upsampled samples neighboring the short side such that the number of upsampled samples neighboring the short side and the number of samples neighboring the long side combined equals a value that is a power of 2.

In another example, to decode the current block of video data using intra DC mode prediction, the video decoder upsamples the number of samples neighboring the short side to determine a number of upsampled samples neighboring the short side and downsamples the number of samples neighboring the long side to determine a number of downsampled samples neighboring the long such that the number of upsampled samples neighboring the short side and the number of downsampled samples neighboring the long side combined equals a value that is a power of 2.

In another example, to decode the current block of video data using intra DC mode prediction, the video decoder downsamples the number of samples neighboring the short side to determine a number of downsampled samples neighboring the short side and downsamples the number of samples neighboring the long side to determine a number of downsampled samples neighboring the long such that the number of downsampled samples neighboring the short side and the number of downsampled samples neighboring the long side combined equals a value that is a power of 2.

The video decoder outputs a decoded version of the current picture that includes a decoded version of the current block (210). When the video decoder is a video decoder configured to output displayable decoded video, then the video decoder may, for example, output the decoded version of the current picture to a display device. When the decoding is performed as part of a decoding loop of a video encoding process, then the video decoder may store the decoded version of the current picture as a reference picture for use in encoding another picture of the video data.

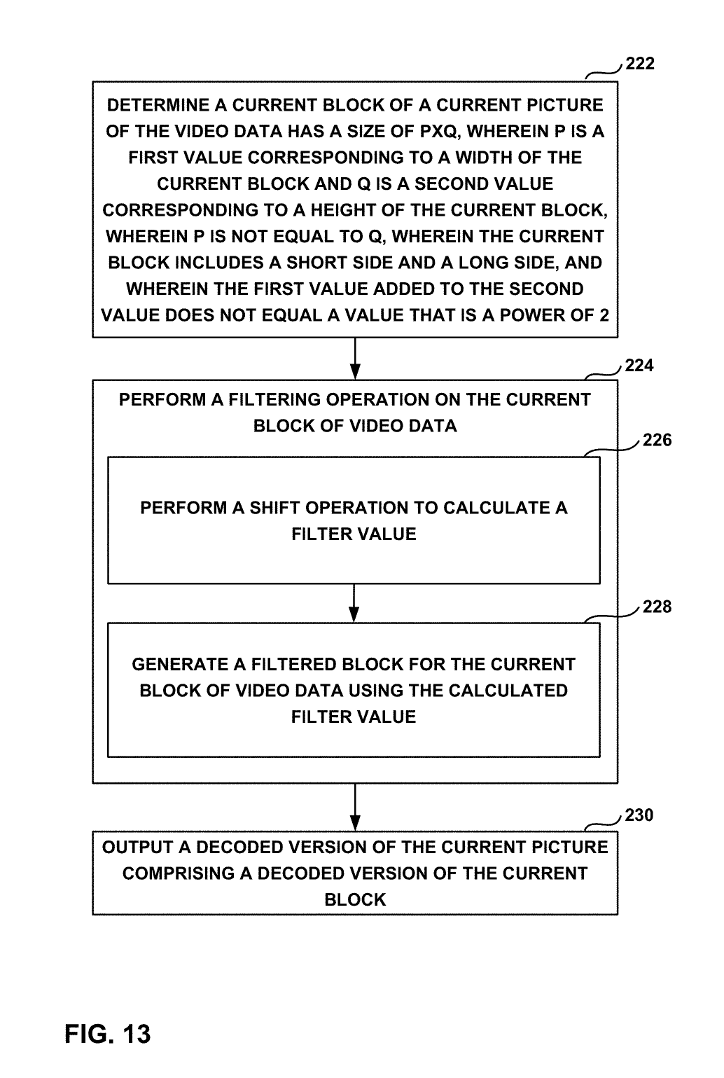

FIG. 13 is a flowchart illustrating an example operation of a video decoder for decoding video data in accordance with a technique of this disclosure. The video decoder described with respect to FIG. 13 may, for example, be a video decoder, such as video decoder 30, for outputting displayable decoded video or may be a video decoder implemented in a video encoder, such as the decoding loop of video encoder 22, a portion of which includes prediction processing unit 100 and summer 112.

In accordance with the techniques of FIG. 13, the video decoder determines a current block of a current picture of the video data has a size of P×Q, with P being a first value corresponding to a width of the current block and Q being a second value corresponding to a height of the current block, and P not being equal to Q (222). The current block includes a short side and a long side, and the first value added to the second value does not equal a value that is a power of 2.

The video decoder performs a filtering operation on the current block of video data (224). To perform the filtering operation on the current block of video data, the video decoder performs a shift operation to calculate a filter value (226) and generates a filtered block for the current block of video data using the calculated filter value (228). To perform the filtering operation on the current block of video data, the video decoder may, for example, downsample the number of samples neighboring the long side to determine a number of downsampled samples neighboring the long side such that the number of downsampled samples neighboring the long side and the number of samples neighboring the short side combined equals a value that is a power of 2. To downsample the number of samples neighboring the long side, the video decoder may, for example, ignore some samples. To perform the filtering operation on the current block of video data, the video decoder may, for example, upsample the number of samples neighboring the short side to determine a number of upsampled samples neighboring the short side such that the number of upsampled samples neighboring the short side and the number of samples neighboring the long side combined equals a value that is a power of 2. To upsample the number of samples neighboring the short side, the video decoder may, for example, assign default values to samples without corresponding actual values.

The video decoder outputs a decoded version of the current picture comprising a decoded version of the current block (230). When the video decoder is a video decoder configured to output displayable decoded video, then the video decoder may, for example, output the decoded version of the current picture to a display device. When the decoding is performed as part of a decoding loop of a video encoding process, then the video decoder may store the decoded version of the current picture as a reference picture for use in encoding another picture of the video data.

Certain aspects of this disclosure have been described with respect to extensions of the HEVC standard for purposes of illustration. However, the techniques described in this disclosure may be useful for other video coding processes, including other standard or proprietary video coding processes not yet developed.

A video coder, as described in this disclosure, may refer to a video encoder or a video decoder. Similarly, a video coding unit may refer to a video encoder or a video decoder. Likewise, video coding may refer to video encoding or video decoding, as applicable. In this disclosure, the phrase “based on” may indicate based only on, based at least in part on, or based in some way on. This disclosure may use the term “video unit” or “video block” or “block” to refer to one or more sample blocks and syntax structures used to code samples of the one or more blocks of samples. Example types of video units may include CTUs, CUs, PUs, transform units (TUs), macroblocks, macroblock partitions, and so on. In some contexts, discussion of PUs may be interchanged with discussion of macroblocks or macroblock partitions. Example types of video blocks may include coding tree blocks, coding blocks, and other types of blocks of video data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining a current block of a current picture of the video data has a size of P×Q, wherein P is a first value corresponding to a width of the current block and Q is a second value corresponding to a height of the current block, wherein P is not equal to Q, wherein the current block includes a short side and a long side, and wherein the first value added to the second value does not equal a value that is a power of 2;
decoding the current block of video data using intra DC mode prediction, wherein decoding the current block of video data using intra DC mode prediction comprises:
performing a shift operation to calculate a DC value; and
generating a prediction block for the current block of video data using the calculated DC value; and
outputting a decoded version of the current picture comprising a decoded version of the current block.

2. The method of claim 1, wherein decoding the current block of video data using intra DC mode prediction further comprises:
determining a first average sample value for the samples neighboring the short side using the shift operation;
determining a second average value for the samples neighboring the long side using the shift operation; and
calculating the DC value by determining an average value of the first average value and the second average value using the shift operation.

3. The method of claim 2, wherein determining the average value of the first average value and the second average value comprises determining a weighted average value of the first average value and the second average value comprises.

4. The method of claim 1, wherein decoding the current block of video data using intra DC mode prediction further comprises:
downsampling a number of samples neighboring the long side to determine a number of downsampled samples neighboring the long side such that the number of downsampled samples neighboring the long side and the number of samples neighboring the short side combined equals a value that is a power of 2.

5. The method of claim 1, wherein decoding the current block of video data using intra DC mode prediction further comprises:
upsampling a number of samples neighboring the short side to determine a number of upsampled samples neighboring the short side such that the number of upsampled samples neighboring the short side and the number of samples neighboring the long side combined equals a value that is a power of 2.

6. The method of claim 1, wherein decoding the current block of video data using intra DC mode prediction further comprises:
upsampling a number of samples neighboring the short side to determine a number of upsampled samples neighboring the short side;
downsampling a number of samples neighboring the long side to determine a number of downsampled samples neighboring the long such that the number of upsampled samples neighboring the short side and the number of downsampled samples neighboring the long side combined equals a value that is a power of 2.

7. The method of claim 1, wherein decoding the current block of video data using intra DC mode prediction further comprises:
downsampling a number of samples neighboring the short side to determine a number of downsampled samples neighboring the short side;
downsampling a number of samples neighboring the long side to determine a number of downsampled samples neighboring the long such that the number of downsampled samples neighboring the short side and the number of downsampled samples neighboring the long side combined equals a value that is a power of 2.

8. The method of claim 1, wherein the method of decoding is performed as part of a decoding loop of a video encoding process, and wherein outputting a decoded version of the current picture comprises storing the decoded version of the current picture as a reference picture for use in encoding another picture of the video data.

9. The method of claim 1, wherein outputting the decoded version of the current picture comprises outputting the decoded version of the current picture to a display device.

10. A device for decoding video data, the device comprising:
one or more storage media configured to store the video data; and
one or more processors configured to:
determine a current block of a current picture of the video data has a size of P×Q, wherein P is a first value corresponding to a width of the current block and Q is a second value corresponding to a height of the current block, wherein P is not equal to Q, wherein the current block includes a short side and a long side, and wherein the first value added to the second value does not equal a value that is a power of 2;
decode the current block of video data using intra DC mode prediction, wherein decoding the current block of video data using intra DC mode prediction comprises:
perform a shift operation to calculate a DC value; and
generate a prediction block for the current block of video data using the calculated DC value; and
output a decoded version of the current picture comprising a decoded version of the current block.

11. The device of claim 10, wherein to decode the current block of video data using intra DC mode prediction, the one or more processors are further configured to:
determine a first average sample value for the samples neighboring the short side using the shift operation;
determine a second average value for the samples neighboring the long side using the shift operation; and
calculate the DC value by determining an average value of the first average value and the second average value using the shift operation.

12. The device of claim 11, wherein to determine the average value of the first average value and the second average value, the one or more processors are further configured to determine a weighted average value of the first average value and the second average value comprises.

13. The device of claim 10, wherein to decode the current block of video data using intra DC mode prediction, the one or more processors are further configured to:
downsample a number of samples neighboring the long side to determine a number of downsampled samples neighboring the long side such that the number of downsampled samples neighboring the long side and the number of samples neighboring the short side combined equals a value that is a power of 2.

14. The device of claim 10, wherein to decode the current block of video data using intra DC mode prediction, the one or more processors are further configured to:
upsample a number of samples neighboring the short side to determine a number of upsampled samples neighboring the short side such that the number of upsampled samples neighboring the short side and the number of samples neighboring the long side combined equals a value that is a power of 2.

15. The device of claim 10, wherein to decode the current block of video data using intra DC mode prediction, the one or more processors are further configured to:
upsample a number of samples neighboring the short side to determine a number of upsampled samples neighboring the short side;
downsample a number of samples neighboring the long side to determine a number of downsampled samples neighboring the long such that the number of upsampled samples neighboring the short side and the number of downsampled samples neighboring the long side combined equals a value that is a power of 2.

16. The device of claim 10, wherein to decode the current block of video data using intra DC mode prediction, the one or more processors are further configured to:
downsample a number of samples neighboring the short side to determine a number of downsampled samples neighboring the short side;
downsample a number of samples neighboring the long side to determine a number of downsampled samples neighboring the long such that the number of downsampled samples neighboring the short side and the number of downsampled samples neighboring the long side combined equals a value that is a power of 2.

17. The device of claim 10, to output the decoded version of the current picture, the one or more processors are further configured to store the decoded version of the current picture as a reference picture for use in encoding another picture of the video data.

18. The device of claim 10, wherein to output the decoded version of the current picture, the one or more processors are further configured to output the decoded version of the current picture to a display device.

19. The device of claim 10, wherein the device comprises a wireless communication device further comprising a transmitter configured to transmit encoded video data.

20. The device of claim 19, wherein the wireless communication device comprises a telephone handset and wherein the transmitter is configured to modulate, according to a wireless communication standard, a signal comprising the encoded video data.

21. The device of claim 10, wherein the device comprises a wireless communication device, further comprising a receiver configured to receive encoded video data.

22. The device of claim 21, wherein the wireless communication device comprises a telephone handset and wherein the receiver is configured to demodulate, according to a wireless communication standard, a signal comprising the encoded video data.

23. An apparatus for decoding video data, the apparatus comprising:
means for determining a current block of a current picture of the video data has a size of P×Q, wherein P is a first value corresponding to a width of the current block and Q is a second value corresponding to a height of the current block, wherein P is not equal to Q, wherein the current block includes a short side and a long side, and wherein the first value added to the second value does not equal a value that is a power of 2;
means for decoding the current block of video data using intra DC mode prediction, wherein the means for decoding the current block of video data using intra DC mode prediction comprises:
means for performing a shift operation to calculate a DC value; and
means for generating a prediction block for the current block of video data using the calculated DC value; and
means for outputting a decoded version of the current picture comprising a decoded version of the current block.

24. The apparatus of claim 23, wherein the means for decoding the current block of video data using intra DC mode prediction further comprises:
means for determining a first average sample value for the samples neighboring the short side using the shift operation;
means for determining a second average value for the samples neighboring the long side using the shift operation; and
means for calculating the DC value by determining an average value of the first average value and the second average value using the shift operation.

25. The apparatus of claim 24, wherein the means for determining the average value of the first average value and the second average value comprises means for determining a weighted average value of the first average value and the second average value comprises.

26. The apparatus of claim 23, wherein the means for decoding the current block of video data using intra DC mode prediction further comprises:
means for downsampling a number of samples neighboring the long side to determine a number of downsampled samples neighboring the long side such that the number of downsampled samples neighboring the long side and the number of samples neighboring the short side combined equals a value that is a power of 2.

27. The apparatus of claim 23, wherein the means for decoding the current block of video data using intra DC mode prediction further comprises:
means for upsampling a number of samples neighboring the short side to determine a number of upsampled samples neighboring the short side such that the number of upsampled samples neighboring the short side and the number of samples neighboring the long side combined equals a value that is a power of 2.

28. The apparatus of claim 23, wherein the means for decoding the current block of video data using intra DC mode prediction further comprises:
means for upsampling a number of samples neighboring the short side to determine a number of upsampled samples neighboring the short side;
means for downsampling a number of samples neighboring the long side to determine a number of downsampled samples neighboring the long such that the number of upsampled samples neighboring the short side and the number of downsampled samples neighboring the long side combined equals a value that is a power of 2.

29. The apparatus of claim 23, wherein the means for decoding the current block of video data using intra DC mode prediction further comprises:
means for downsampling a number of samples neighboring the short side to determine a number of downsampled samples neighboring the short side;
means for downsampling a number of samples neighboring the long side to determine a number of downsampled samples neighboring the long such that the number of downsampled samples neighboring the short side and the number of downsampled samples neighboring the long side combined equals a value that is a power of 2.

30. The apparatus of claim 23, wherein the means for outputting the decoded version of the current picture comprises means for storing the decoded version of the current picture as a reference picture for use in encoding another picture of the video data.

31. The apparatus of claim 23, wherein the means for outputting the decoded version of the current picture comprises means for outputting the decoded version of the current picture to a display device.
